(19) United States
(12) Patent Application Publication
(10) Pub. No.: US 2012/0285710 A1
(43) Pub. Date: Nov. 15, 2012

(54) DISASTER-PREVENTING DEVICE

(76) Inventors: Hiroshi Umehara, Tokyo (JP); Yuji Sugie, Shibukawa (JP)

(21) Appl. No.: 13/558,535

(22) Filed: Jul. 26, 2012

Related U.S. Application Data
(63) Continuation of application No. PCT/JP2010/060732, filed on Jun. 24, 2010.

(51) Int. Cl. A62C 37/36

(52) U.S. Cl. 169/61; 169/56

(57) ABSTRACT

[Problem to be Solved] A low-cost simple extinguishing device, which is installed in small space such as the interior of a board and carries out fire detection and extinguishment, is provided.

[Solution] A disaster-preventing device 10 is provided with: a battery that supplies a power source; a fire detecting unit 12 that detects fire; and an aerosol generating unit 14 that generates and discharges, to outside, aerosol for extinguishment by combustion of a solid extinguishing agent when the fire detecting unit 12 detects the fire. The fire detecting unit 12 outputs fire warning by sound and display when the fire is detected. The disaster-preventing device 10 can be installed at an arbitrary position in the interior of the board by a magnet sheet 32.

### TECHNICAL FIELD

The present invention relates to a disaster-preventing device that promptly detects and extinguishes fire generated in small closed space such as the interior of a board of a server rack, distribution board, or cubicle, the interior of a copying machine, or the vehicle-interior or engine room of an automobile.

### BACKGROUND ART

Conventionally, for example, device boards of server racks, panelboards, various control boards, cubicles, etc. include device boards that house electric equipment in chassis serving as closed space. In many cases, a plurality of such device boards are installed in an installation room such as a communication equipment room or an electric room. In the installation room, fire monitoring has been carried out by using a fire detecting system which disposes a smoke detector or a heat detector, captures the temperature in the room, temperature increase, or smoke generation, and emits a fire detection signal to a remotely-disposed fire receiver or by using a high-sensitive fire detecting system which connects sampling tubes to a plurality of control boards, detects smoke particles in the air drawn in by a pump from room-interior space by a high-sensitive smoke detector to capture smoke generation, and emits a fire detection signal. In combination with it, gas extinguishing equipment, preliminary-activation-type sprinkler equipment, etc. are installed, and an extinguishing device is activated based on the fire detection signal to carry out extinguishment activity; or a gas extinguishing device or an extinguisher is installed for each control board, and fire extinguishment control upon occurrence of fire is configured to be carried out by using a system that carries out an extinguishing activation by automatically activating or manually operating the extinguishing device based on a fire signal of each control board.

The extinguishment control in this case is generally entire-room-area extinguishment in which an extinguishing agent is sprayed to the entirety of interior of the installation room. Such fire is often caused by heat generation, smoke generation, fire generation, or the like caused by, for example, abnormal power distribution of the electric equipment in the device board. Therefore, in some cases, for example, a tube filled with an extinguishing agent with high pressure is housed in a chassis of each device board separately from the above described fire monitoring and extinguishing equipment so that the extinguishing agent is jetted when the tube is ruptured by heat upon fire.

### CITATION LIST

### Patent Literature

Patent Literature 1: Japanese Patent Application Laid-Open No. 2004-078807
Patent Literature 2: Japanese Patent Application Laid-Open No. 2009-142419
Patent Literature 3: Japanese Patent Application Laid-Open No. 2009-142420
Patent Literature 4: Japanese Patent Application Laid-Open No. 2009-160382

### DISCLOSURE OF INVENTION

### Problems to be Solved by the Invention

However, such conventional disaster-preventing devices have below problems.

First, it takes time until the heat or smoke of fire generated in a closed chassis of a device board is detected by a fire detector provided on a ceiling or wall surface in an installation room.

Therefore, there is a problem that the scale of a fire is expanded before the fire is detected, wherein the fire spreads also to adjacent device boards. For example in the case of entire-area gas extinguishing equipment, an extinguishing gas is discharged into the entire room in accordance with activation of a smoke detector or heat detection in a room or by manual operation by a person who has noticed occurrence of fire, wherein there is a problem that the gas does not easily reach the point of fire in the closed chassis. Particularly, for example, in the case in which a ventilating device using a fan is provided like a server rack, it may be impossible to supply the amount of the extinguishing gas required for extinguishment into the control board in which fire has occurred. Moreover, since the extinguishing gas is discharged into the entire room, people cannot enter the room after the discharge, and countermeasures thereafter may be disturbed. Moreover, since the entirety of a gas container is replaced after the extinguishing gas is discharged, there is a problem, for example, that cost is taken. Moreover, installation space for a large gas cylinder is required in order to ensure predetermined extinguishing performance, and set-up for piping is required; therefore, there is a problem that facility cost is large and an economic burden is increased. Furthermore, installation in an existing building has a problem that there is a large restriction due to a problem for, for example, ensuring space.

On the other hand, in the case in which a fire detecting/extinguishing device using, for example, tubes as described above is installed in a device board, there is an advantage that facility cost can be significantly reduced compared with the entire-area gas extinguishing equipment; however, there is a problem that equipment in the device board is damaged more than necessity due to, for example, the jetting pressure of the extinguishing agent or rupture and scattering of the tubes. Moreover, since it is a heat-sensitive type, there is also a problem that the device is not easily activated for early-stage cable fire that is not accompanied by sufficient heat generation.

It is an object of the present invention to provide a disaster-preventing device, which solves the above described problems, is installed particularly in small closed space such as in a device board so that fire detection and extinguishment can be promptly carried out, and is small and easy to handle.

### Solution to Problems

The present invention is a disaster-preventing device provided with: a battery that supplies a power source; a fire detecting unit that detects fire; and an aerosol generating unit that, when the fire detecting unit detects the fire, generates and discharges, to outside, aerosol by combustion of a solid extinguishing agent.

The fire detecting unit detects generation of smoke.

The fire detecting unit and the aerosol generating unit are integrally provided.

The fire detecting unit and the aerosol generating unit are disposed to be separated from each other; the aerosol generating unit is connected to the fire detecting unit by a signal line; and the solid extinguishing agent is ignited and combusted by a signal output when the fire detecting unit detects the fire.

The fire detecting unit is provided with: a sensor unit that outputs a detection signal corresponding to a physical phenomenon of a monitoring area; an activation-signal outputting unit that outputs an activation signal to the aerosol generating unit; an event detecting unit that detects whether there is the fire or not according to output of the detection signal of the sensor unit; and a warning processing unit that, when the event detecting unit detects the fire, causes the activation-signal transmitting unit to output the activation signal to the aerosol generating unit to combust the solid extinguishing agent.

The fire detecting unit is further provided with a transferred-alarm unit that outputs a transferred-alarm signal to another disaster-preventing device; and, when the event detecting unit detects reception of a transferred-alarm signal from the other disaster-preventing device, the warning processing unit causes the activation-signal outputting unit to output the activation signal to the aerosol generating unit to combust the solid extinguishing agent.

The fire detecting unit is further provided with a transferred-alarm unit that outputs a transferred-alarm signal to another disaster-preventing device; and, when the event detecting unit detects the fire and detects reception of a transferred-alarm signal from the other disaster-preventing device, the warning processing unit causes the activation-signal outputting unit to output the activation signal to the aerosol generating unit to combust the solid extinguishing agent.

The fire detecting unit is provided with: a sensor unit that outputs a detection signal corresponding to a physical phenomenon of a monitoring area; an activation-signal outputting unit that outputs an activation signal to the aerosol generating unit; an event detecting unit that detects whether there is the fire or not according to output of the detection signal of the sensor unit; a transmission processing unit that wirelessly transmits an event signal to another disaster-preventing device; a reception processing unit that wirelessly receives an event signal from the other disaster-preventing device; and a warning processing unit that, when the event detecting unit detects the fire, causes the activation-signal outputting unit to output the activation signal to the aerosol generating unit to combust the solid extinguishing agent and further causes the transmission processing unit to wirelessly transmit an event signal indicating the fire to the other disaster-preventing device.

When the event detecting unit detects reception of the event signal indicating the fire from the other disaster-preventing device, the warning processing unit of the fire detecting unit causes the activation-signal outputting unit to output the activation signal to the aerosol generating unit to combust the solid extinguishing agent.

When the event detecting unit detects the fire and detects reception of the event signal indicating the fire from the other disaster-preventing device, the warning processing unit of the fire detecting unit causes the activation-signal outputting unit to output the activation signal to the aerosol generating unit to combust the solid extinguishing agent.

The fire detecting unit is further provided with a heat-sensitive cable that is installed in a warning area and brings a pair of signal lines into contact with each other to obtain a short-circuited state by melting of insulating coating thereof when heat is received by the fire; and, when the heat-sensitive cable is short-circuited, the activation-signal outputting unit outputs the activation signal to the aerosol generating unit to combust the solid extinguishing agent.

The activation-signal outputting unit is provided with: a switching element that is activated by an activation ordering signal output from the warning processing unit; heat-sensitive terminals that connect the pair of signal lines of the heat-sensitive cable in parallel with the switching element; and an activation line terminal that outputs the activation signal to the aerosol generating unit when the switching element is activated or when the heat-sensitive cable is short-circuited.

The fire detecting unit is further provided with a heat-sensitive cable that brings a pair of signal lines into contact with each other to obtain a short-circuited state by melting of insulating coating thereof when heat is received by the fire; and, when an activation ordering signal is output from the warning processing unit and the heat-sensitive cable is short-circuited, the activation-signal outputting unit outputs the activation signal to the aerosol generating unit to combust the solid extinguishing agent.

The activation-signal outputting unit is provided with: a switching element that is activated by an activation ordering signal output from the warning processing unit; heat-sensitive terminals that connect the pair of signal lines of the heat-sensitive cable in series with the switching element; and an activation line terminal that outputs the activation signal to the aerosol generating unit when the switching element is activated and the heat-sensitive cable is short-circuited.

The fire detecting unit is further provided with a heat-sensitive cable that is installed in a warning area and brings a pair of signal lines into contact with each other to obtain a short-circuited state by melting of insulating coating thereof when heat is received by the fire; and the activation-signal outputting unit is provided with: an OR activation unit that, when an activation ordering signal is output from the warning processing unit or when the heat-sensitive cable is short-circuited, outputs the activation signal to the aerosol generating unit to combust the solid extinguishing agent, an AND activation unit that, when the activation ordering signal is output from the warning processing unit and the heat-sensitive cable is short-circuited, outputs the activation signal to the aerosol generating unit to combust the solid extinguishing agent, and a switching unit that switches the OR activation unit and the AND activation unit.

The aerosol generating unit is provided with: the solid extinguishing agent that is provided with a communication hole from an opening on a surface to interior thereof and generates the extinguishing aerosol from the opening via the communication hole by combustion; an ignition device that is housed in the communication hole and ignites and combusts the solid extinguishing agent; an inner container that houses the solid extinguishing agent; and an outer container that supports, in interior thereof, the inner container with interposition of heat-insulating space and have a plurality of discharging openings formed in an outer periphery.

The aerosol generating unit is further provided with a combustion controlling member that is provided with a discharging hole at a position corresponding to the opening of the solid extinguishing agent, is disposed to cover a surface of the solid extinguishing agent around the opening, and suppresses combustion of the surface of the solid extinguishing agent due to flame emitted from the discharging hole.

### Advantageous Effects of the Invention

According to a fire extinguishing device of the present invention, when fire generated in a device board of, for example, a server rack, a panelboard, or a cubicle is detected by the fire detecting unit, the solid extinguishing agent housed in the aerosol generating unit disposed to be integrated with or separated from the fire detecting unit is ignited and combusted to discharge the extinguishing aerosol into the device board, and the fire of electric equipment or electric wiring cables housed in the device board can be reliably extinguished.

The extinguishing aerosol is generated by the combustion of the solid extinguishing agent; therefore, the disaster-preventing device composed of the fire detecting unit and the aerosol generating unit can be realized as a compact disaster-preventing device downsized to a size that can be placed on a palm. Furthermore, since it is operated by the battery power source, electric power supply from outside is not required, and the device can be simply and easily attached not to mention to a new device board and also to an existing device board by attraction caused by, for example, a magnet.

According to the disaster-preventing device of the present invention, fire can be promptly detected at a small-size stage, and extinguishing operation can be efficiently started on site. Therefore, the size of the extinguishing device for an entire installation room can be reduced, and equipment cost can be significantly reduced compared with an existing extinguishing device. Since the size, weight, and cost of the disaster-preventing device are reduced, even when the extinguishing device is installed for each device board, the equipment cost as a whole can be significantly reduced.

When the disaster-preventing device of the present invention is applied in addition to conventional fire monitoring/extinguishing equipment, the fire monitoring/extinguishing performance as a whole can be significantly improved.

In the disaster-preventing device of the present invention, even though it is operated by the battery power source, an operating period over a long period such as 10 years can be realized, and fire detection and extinguishment can be carried out with high reliability for the long period.

When once fire has been detected and extinguishment by aerosol discharge has been carried out, a measure can be taken simply with low cost only by detaching the used disaster-preventing device and replacing it with a new one.

The fire detecting unit of the disaster-preventing device is provided with an alarming function that outputs fire warning when fire is detected. The sound of the fire warning is output in the device board in combination upon extinguishing operation carried out by discharging the aerosol in the device board by combustion of the solid extinguishing agent; and, when the warning is heard outside the device board, the fire detection and the extinguishing operation by the disaster-preventing device can be found out.

The extinguishing ability of the disaster-preventing device is determined depending on the weight of the solid extinguishing agent corresponding to the volume of installation space.

If the extinguishment target space is large, a measure can be simply taken by increasing the number of installed extinguishing units in accordance with needs.

In the case in which a plurality of disaster-preventing devices are installed in the same device board, extinguishing-unit activation signal lines from fire detecting units are mutually connected. As a result, if fire is detected by the fire detecting unit of any one of the extinguishing devices, discharge of aerosol can be started at the same time or sequentially to carry out extinguishment by igniting and combusting the solid extinguishing agents provided in the extinguishing device, which has detected the fire, and the extinguishing units of the other extinguishment disaster-preventing devices connected by the activation signal line. In the case of a disaster-preventing device provided with a fire detecting unit of a wireless-cooperation type, the aerosol can be discharged at the same time from the plurality of disaster-preventing devices in cooperation by radio communication to carry out extinguishment without mutual connection by the signal lines.

For example, if two extinguishing devices are installed in the same device board, transferred-alarm signal lines thereof are mutually connected, or they are cooperated by wireless communication. As a result, if fire is detected by the fire detecting units of both of the disaster-preventing devices, AND processing operation that activates the aerosol generating units is carried out based on the fire detection of both of the fire detecting units, thereby reliably preventing erroneous operation. As a matter of course, similar cooperation can be carried out, not only in the same device board, but also between the disaster-preventing devices respectively housed in mutually-adjacent device boards.

### BRIEF DESCRIPTION OF THE DRAWINGS

FIGS. 1A and 1B are explanatory drawings showing an embodiment of a disaster-preventing device according to the present invention.

FIG. 2 is a cross-sectional view showing the structure of an aerosol generating unit of the disaster-preventing device shown in FIGS. 1A and 1B.

FIG. 3 is an explanatory drawing showing a disassembled state of the aerosol generating unit of FIG. 2.

FIG. 4 is an explanatory drawing showing extinguishing operation by the aerosol generating unit of FIG. 2.

FIG. 5 is an explanatory drawing showing an embodiment of a separated-type disaster-preventing device according to the present invention.

FIG. 6 is a block diagram showing a functional configuration of a standalone-type disaster-preventing device according to the present invention.

FIG. 7 is a flow chart showing a processing operation according to the disaster-preventing device of FIG. 6.

FIG. 8 is a block diagram showing a functional configuration of a wireless-cooperation type disaster-preventing device according to the present invention.

FIG. 9 is an explanatory drawing showing a format of an event signal used in the disaster-preventing device of FIG. 8.

FIG. 10 is a flow chart showing a processing operation by the disaster-preventing device of FIG. 8.

FIG. 11 is an explanatory drawing showing an installation example in which each of extinguishing devices of the standalone-type of FIG. 6 is installed for each of device boards.

FIG. 12 is an explanatory drawing showing an installation example in which two disaster-preventing devices of the standalone-type of FIG. 6 are installed for each of device boards.

FIG. 13 is a flow chart showing an OR linked processing operation with respect to the installation example of FIG. 12.

FIGS. 14A and 14B are flow charts showing an AND linked processing operation with respect to the installation example of FIG. 12.

FIG. 15 is an explanatory drawing showing an installation example in which disaster-preventing devices of the standalone-type of FIG. 6 are installed in mutually adjacent device boards and connected to each other by transferred-alarm signal lines.

FIG. 16 is an explanatory drawing showing an installation example of disaster-preventing devices of the separated-type shown in FIG. 5.

FIG. 17 is an explanatory drawing showing an installation example in which two disaster-preventing devices of the wireless-cooperation type of FIG. 8 are installed with respect to each of device boards.

FIG. 18 is a flow chart showing an OR linked processing operation with another disaster-preventing device in the extinguishing device of FIG. 8.

FIGS. 19A and 19B are flow charts showing an AND linked processing operation with another disaster-preventing device in the extinguishing device of FIG. 8.

FIG. 20 is an explanatory drawing showing an installation example in which disaster-preventing devices of the stand-alone type of FIG. 8 are installed in mutually adjacent device boards and connected by a transferred-alarm signal line.

FIG. 21 is an explanatory drawing showing an installation example of disaster-preventing devices connecting heat-sensitive lines to device boards.

FIGS. 22A and 22B are block diagrams showing a functional configuration of the disaster-preventing device of FIG. 21.

FIG. 23 is a circuit diagram showing an embodiment of an activation-signal outputting unit in the disaster-preventing device of FIGS. 22A and 22B which is connected to a heat-sensitive cable and carries out an OR activation operation.

FIG. 24 is a circuit diagram showing an embodiment of the activation-signal outputting unit in the disaster-preventing device of FIGS. 22A and 22B which is connected to a heat-sensitive cable to carry out an AND activation operation.

FIG. 25 is a circuit diagram showing an embodiment of the activation-signal outputting unit in the disaster-preventing device of FIGS. 22A and 22B which carries out the OR activation operation with the heat-sensitive cable by switching.

FIG. 26 is a circuit diagram showing the state in which the activation-signal outputting unit of FIG. 25 is switched to the AND activation operation.

### BEST MODES FOR CARRYING OUT THE INVENTION

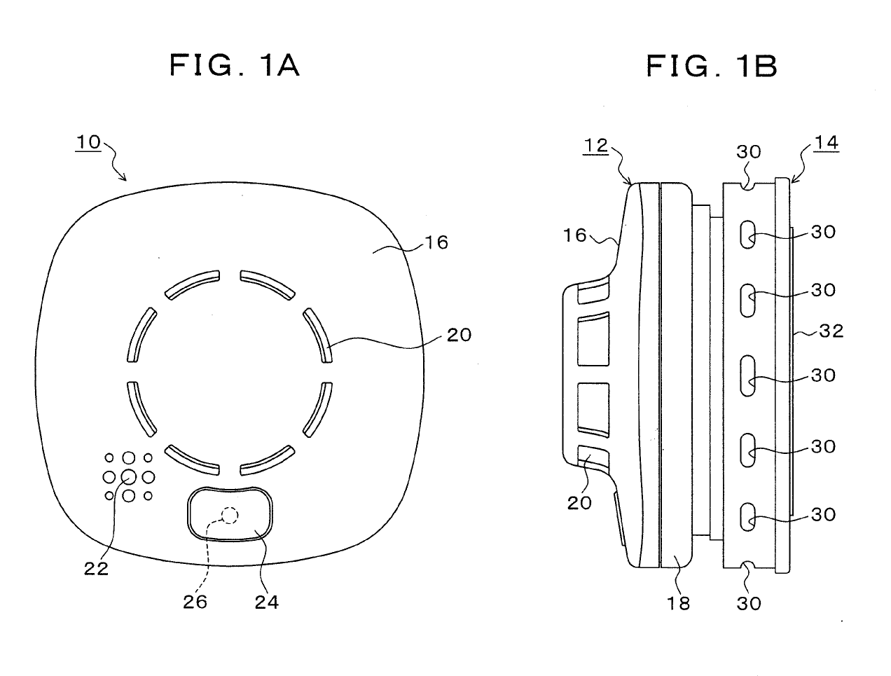

FIGS. 1A and 1B are explanatory drawings showing external views of an embodiment of a disaster-preventing device according to the present invention. FIG. 1A shows a front view, and FIG. 1B shows a lateral view. In FIGS. 1A and 1B, the disaster-preventing device 10 of the present embodiment is composed of a fire detecting unit 12 and an aerosol generating unit 14 disposed in back thereof. A chassis of the fire detecting unit 12 is composed of a cover 16 and a main body 18.

A projecting part is provided at the center of the cover 16, a plurality of smoke inlets are formed around it, and a smoke detecting unit 20 is disposed therein so that fire is detected when smoke caused by fire flows into the smoke detecting unit and reaches a predetermined concentration. Acoustic holes 22 are provided in the lower left side of the projecting part provided in the cover 16, a buzzer or a speaker is incorporated in the back thereof so that a warning sound or sound message can be output. A warning stopping switch 24 is provided in the lower side of the projecting part.

The warning stopping switch 24 is composed of a switch cover formed of a semitransparent member and a tact switch (not illustrated) disposed in the switch cover. In the vicinity of the tact switch in the switch cover, a LED 26, which carries out display of warning or the like, is disposed as shown by a dotted line so that, when the LED 26 undergoes actuation of lighting, blinking, or flickering, the actuation state of the LED 26 can be visually checked from outside through the part of the switch cover of the warning stopping switch 24. The warning stopping switch 24 functions as a warning stopping switch or an inspection switch depending on the operating state of the fire detecting unit 12 at the point of operation. For example, if the warning stopping switch 24 is operated upon fire warning of the fire detecting unit 12, the switch functions as a warning stopping switch which stops the warning.

If the warning stopping switch 24 is operated in a normal state of the fire detecting unit 12, the switch functions as an inspection switch which executes predetermined inspection operations to output the result of the inspection by a sound message.

As the fire detecting unit 12 of FIGS. 1A and 1B, a fire detecting unit which is provided with the smoke detecting unit 20 and detects smoke caused by fire is taken as an example; however, a fire detecting unit provided with a temperature detecting element such as a thermistor which detects heat caused by fire is also included as an example other than that. The aerosol generating unit 14 serving as an aerosol generating unit is a disk-like unit and is fixedly disposed or attachably/detachably disposed in back of the fire detecting unit 12. In accordance with needs, a heat-insulating material (not illustrated) is interposed between the fire detecting unit 12 and the aerosol generating unit 14 so that the heat generated when the aerosol generating unit 14 is activated does not affect the operation, etc. of the fire detecting unit 12.

A solid extinguishing agent is housed in the aerosol generating unit 14, and an activation signal line from the fire detecting unit 12 is connected to an ignition device provided at the solid extinguishing agent. When fire is detected by the fire detecting unit 12, power is distributed to the ignition device to ignite the solid extinguishing agent, and aerosol for extinguishment is generated by combusting the solid extinguishing agent and discharged from discharging openings 30 formed in the periphery to outside. An activation signal from the fire detecting unit 12 is, for example, a wet contact signal. A magnet sheet 32 is provided on a back surface of the aerosol generating unit 14 so that the aerosol generating unit can be installed at an arbitrary position in a device board by magnetic attraction caused by the magnet sheet 32.

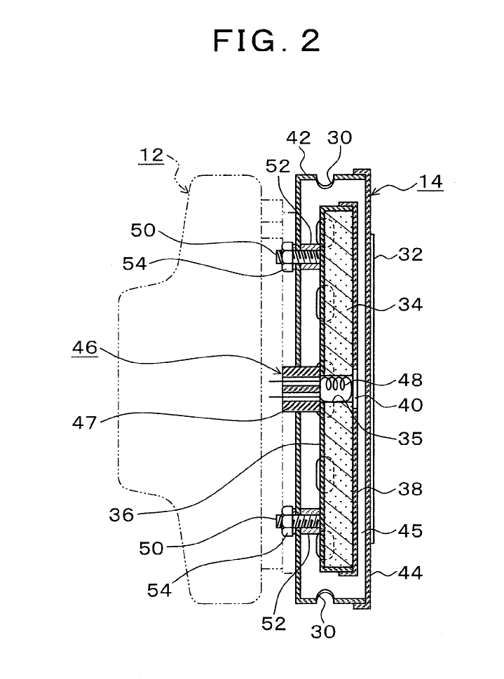

FIG. 2 is a cross-sectional view showing, as an example, the internal structure of the aerosol generating unit 14 of FIGS. 1A and 1B. In FIG. 2, the aerosol generating unit 14 of the present embodiment houses a solid extinguishing agent 34 in an inner container 36 serving as an extinguishing-agent container, and a combustion controlling cover 38 is fixedly disposed so as to be in contact with the solid extinguishing agent 34 by the surfaces thereof. A discharging hole 40 is formed at the center of the combustion controlling cover 38. The inner container 36 and the combustion controlling cover 38 constitute a thin cylindrical container, and a metal case or the like is used therefore. The solid extinguishing agent 34 has the shape of a doughnut, in which a through hole (communication hole) 35 is formed in the central-axis direction thereof, and generates powder aerosol when combusted. The composition of the extinguishing agent used in the solid extinguishing agent 34 is not particularly limited; however, a smoke-generation extinguishing-agent composition mainly composed of an alkali metal salt is preferred to be used. As the alkali metal salt, specifically, an alkali metal salt selected from: potassium chlorate, potassium perchlorate, potassium dichromate, cesium nitrate, potassium nitrate, etc. is preferred. In terms of ease of acquisition, cost, etc., potassium chlorate or potassium perchlorate can be more preferably selected. Such an alkali metal salt containing a reactant that acts as a reducing agent is further preferred. No particular limitation is imposed on the reducing agent; and a polymer material such as rubber, an unsaturated polyester resin, an epoxy resin, a phenol resin, a phenol-formaldehyde resin can be used. Furthermore, a combustion adjusting agent and a metal reductant may be separately mixed with the extinguishing-agent composition used in the present invention. As the combustion adjusting agent, a salt such as potassium chloride, potassium carbonate, potassium hydrogen carbonate, sodium chloride, sodium carbonate, sodium hydrogen carbonate, talc, diatomite, glass powder can be used. Examples of the metal reductant include magnesium, aluminum, and silicon. According to these, for example, an extinguishing-agent composition that is mainly composed of an oxidizing agent typified by potassium perchlorate, is mixed with the reducing agent such as a resin and with, arbitrarily, the combustion adjusting agent and a metal reductant, and is molded can be used. The aerosol generated by combustion of the solid extinguishing agent 34 is ultrafine particles having a particle size of 1 μm or less, and the component thereof contains a carbonate, a chloride, or an oxide or a mixture thereof. Specifically, the aerosol is agglomerated particles of, for example, potassium chloride, sodium chloride, potassium carbonate, or potassium oxide; and, other than that, nitrogen, carbon dioxide, water vapor, etc. are contained. The aerosol carries out extinguishment by filling a monitoring area, in which fire has occurred, and suppressing and extinguishing the fire center of combustion at the fire occurrence site. Since the main component of the aerosol is carbonate, chloride, oxide, or the like, the aerosol is free from toxicity and has characteristics that have small load on the environment. The relation between the weight of the solid extinguishing agent 34, which generates the aerosol by combustion, and the volume of extinguishment target space applicable to exert appropriate extinguishing performance is, for example, as described below.

25 grams for 0.25 cubic meter
50 grams for 0.50 cubic meter
100 grams for 1.00 cubic meter

Based on such relation, the amount of the solid extinguishing agent 34 corresponding to the volume in the device board, in which the extinguishing device 10 of the present embodiment is installed, is housed. However, since the volume of the board in which the extinguishing device 10 is to be installed is various, the weight of the solid extinguishing agent 34 is determined depending on typical board volumes (for example, three types, i.e., large, medium, and small). For a board having a volume larger than those, a plurality of extinguishing devices 10 corresponding to the volume are configured to be installed. The combustion controlling cover 38 is a thin cover member made of metal in which the discharging hole 40 is formed at a position corresponding to the through hole 35 of the solid extinguishing agent 34, is fixed so as to be in contact with the discharging-side surface of the solid extinguishing agent 34, suppresses combustion of the contact part, and discharges a combustion gas containing the aerosol, which has been generated by combustion, from the discharging hole 40 to outside. The through hole 35 provided at approximately the center of the solid extinguishing agent 34 plays the role to determine discharging time. A circular hole is formed as the through hole 35; however, the position, shape, size, and number thereof may be arbitrary depending on required discharging time. The discharging hole 40 provided at approximately the center of the combustion controlling cover 38 plays the role to determine the discharging speed of the aerosol; and the position, shape, size, and number thereof are arbitrarily changed in accordance with needs.

For example, they may be the same as the initial position, shape, size, and number of the through hole 35 or may be changed. The inner container 36 is housed in an outer container 42 in which the plurality of discharging openings 30 are formed in the peripheral lateral surface thereof so as to form a double container structure in which a discharging path 45, which is also serving as a heat-insulating air layer, is formed therebetween.

In the double container structure, bolts 50 are inserted in a plurality of spacers 52 and extended from the inner container 36, the distance between them is set by the length of the spacers 52, and nuts 54 are fastened and fixed to the bolts 50 penetrating through the outer container 42. An ignition device 46 is provided in the through hole 35 of the solid extinguishing agent 34 housed in the inner container 36. The ignition device 46 is provided with a ceramic socket 47 serving as a heat-resistant socket, which penetrates through the outer container 42 and the inner container 36 and is fixed. The ignition device 46 is provided with a heater coil 48, which is disposed so as to be in contact with a lateral wall of the through hole 35 of the solid extinguishing agent 34. The ignition device 46 distributes power to heat the heater coil 48 according to the activation signal from the fire detecting unit 12 so that the solid extinguishing agent 34 is ignited by the heat at the part in contact with the heater coil 48 of the through hole 35 to start combustion. For example, a nichrome wire or a tantalum wire is used as the heater coil 48 of the ignition device 46. The case in which the heater coil is used as the ignition device is taken as an example. However, for example, an ignition device which ignites by mechanical friction caused by rotation of a small motor, an ignition device which ignites by impact, or an ignition device which ignites by reaction heat caused by the contact of two substances may be used.

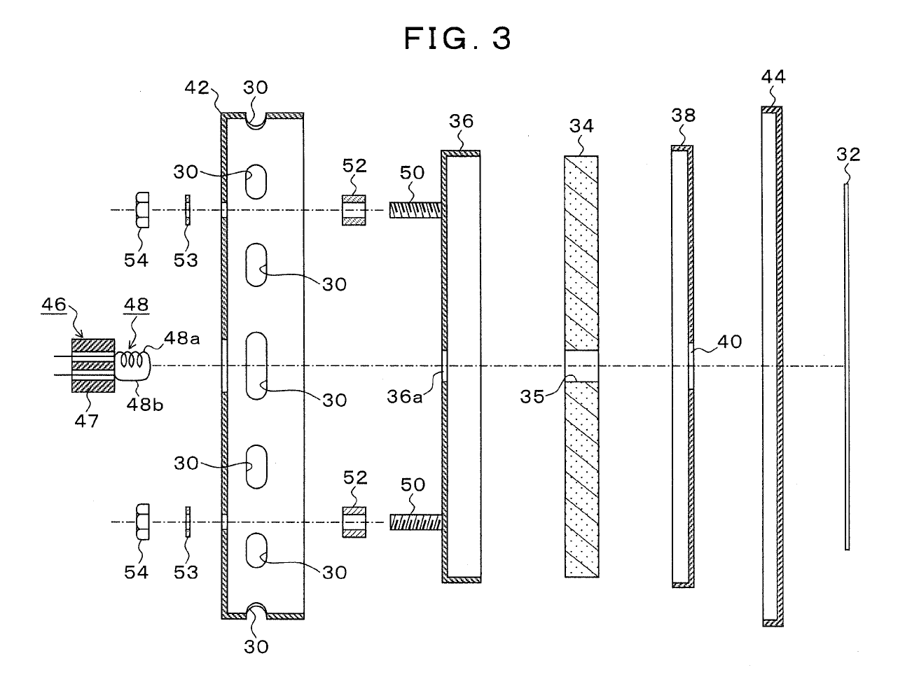

FIG. 3 is an explanatory drawing showing a disassembled state of the aerosol generating unit 14 of FIG. 2. In FIG. 3, the doughnut-shaped solid extinguishing agent 34, in which the through hole 35 for starting combustion is formed in the central-axis direction, is housed in the inner container 36, which is a thin cylindrical body having an opening in the rear (right side in the drawing); and, to the right side thereof, the combustion controlling cover 38, in which the discharging hole 40 is formed at the center thereof, is, for example, pressed in to bring the surface thereof in the left side of the drawing into contact with the surface of the solid extinguishing agent 34 in the right side of the drawing. Therefore, the outer surface of the solid extinguishing agent 34 is covered with the inner container 36, the surface thereof in the discharging side has a housing configuration that it is in contact and covered with the combustion controlling cover 38, and the solid extinguishing agent is communicated with outside only by the discharging hole 40 of the combustion controlling cover 38 corresponding to the through hole 35. The inner container 36, in which the solid extinguishing agent 34 is incorporated and closed with the combustion controlling cover 38, is housed in the outer container 42 in the state in which the spacers 52 are fitting a plurality of bolts 50 extending from the outer surface thereof; distal ends of the bolts 50 are extending through penetration holes of the outer container 42; and nuts 54 are tightened thereat via washers 53, thereby supporting and fixing the inner container 36 in the outer container 42 in a floating state. The outer container 42 is a thin cylindrical body having an opening in the right side of the drawing, and the plurality of discharging openings 30 are formed in the outer peripheral lateral wall thereof. An outer cover 44 is mated with and fixed to the opening side of the outer container 42, and the magnet sheet 32 is attached to an outer surface of the outer cover 44 by, for example, adhesion. The ignition device 46 inserts the heater coil 48 from a socket insertion hole 36a of the inner container 36 and is disposed in the through hole 35 of the solid extinguishing agent 34 with contact therewith. The heater coil 48 connects a coil part 48a and a coil returning part 48b between a pair of terminals provided at the ceramic socket 47. The coil part 48a reliably ensures more points of contact with the solid extinguishing agent 34 by spirally winding a heater wire around at a small pitch. When the heater coil 48 fits in the through hole 35 of the solid extinguishing agent 34, the coil returning part 48b exerts a spring property in the vertical direction of the drawing by a cooperative action with the coil part 48a, thereby bringing the coil part 48a into contact with the inner wall of the through hole 35 with a pressure so that, upon power distribution and heating, the heat of the coil part 48a can be efficiently transmitted to the solid extinguishing agent 34 to reliably carry out ignition.

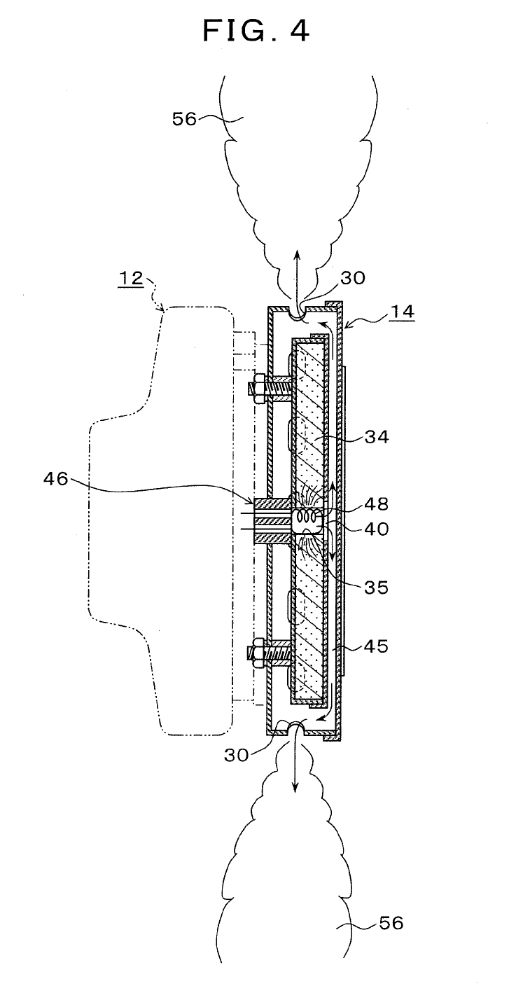

FIG. 4 is an explanatory drawing showing a state in which the aerosol (extinguishing agent) is discharged by combustion of the solid extinguishing agent 34 in the aerosol generating unit 14 of FIG. 2. In FIG. 4, when power is distributed to the heater coil 48 of the ignition device 46 via the signal line 15 of the fire detecting unit 12, combustion of the solid extinguishing agent 34 is started from the inner wall part of the through hole 35 which is in contact with the heater coil 48. Aerosol 56 generated by the combustion of the solid extinguishing agent 34 passes through the discharging hole 40 of the combustion controlling cover 38 from the through hole 35, further passes through the discharging path 45 formed between the inner container 36 and the outer container 42, and is discharged from the discharging openings 30 of the outer container 42 to outside. At this point, the combustion controlling cover 38 is in contact with and fixed to one of the surfaces of the solid extinguishing agent 34, and this surface is not in contact with outside air; therefore, the combustion of the solid extinguishing agent 34 gently progresses from the through hole 35 toward the outer peripheral side. The inner surface of the inner container 36 is also in contact with the lateral surface and bottom surface of the solid extinguishing agent 34 and therefore acts in a manner similar to the combustion controlling cover 38. These also prevent flame upon the combustion from spreading to the surface of the solid extinguishing agent 34. Furthermore, the internal pressure of the inner container 36 is increased by the aerosol generated by the combustion that progresses from the through hole 35 of the solid extinguishing agent 34 toward the outer peripheral side, and the aerosol is swiftly discharged from the discharging hole 40 to the discharging path 45 outside thereof. As a result, while gently suppressing the combustion speed of the solid extinguishing agent 34, the jetting speed of the aerosol 56 is appropriately ensured at the same time, thereby effectively spreading the discharged aerosol in the extinguishment target object and further spreading also an unburnt gas generated upon combustion; therefore, generation and spreading of flame particularly in the vicinity of the discharging hole can be suppressed. The inner container 36 and the combustion suppressing cover 38 are heated by the combustion of the solid extinguishing agent 34, and the temperatures thereof are increased. However, since the discharging path 45, which forms the heat-insulating air layer, is formed between the inner container 36 and the combustion suppressing cover 38 and the outer container 42, thermal conduction to the outer container 42 is suppressed so that the temperature of the outer container 42 is not increased more than a safety range. Furthermore, a heat-insulating material can be interposed between there and the fire detecting unit 12 in accordance with needs to more reliably prevent thermal influence from affecting the fire detecting unit 12.

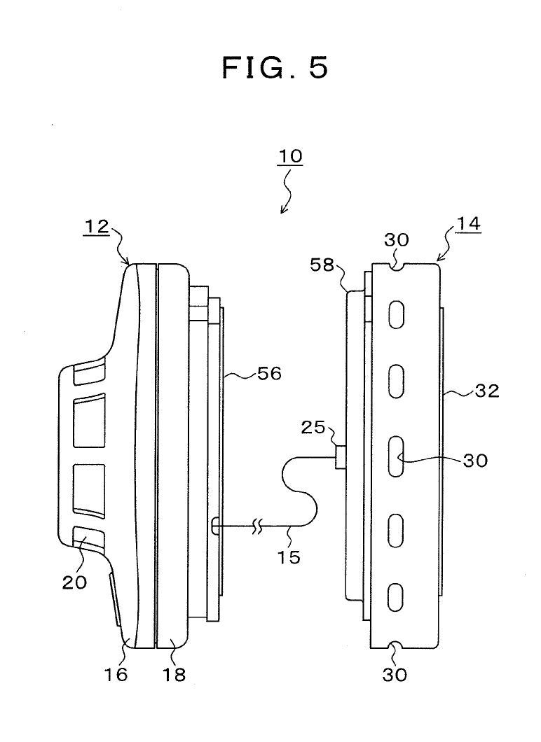

FIG. 5 is an explanatory drawing showing an embodiment of the disaster-preventing device of a separated-type according to the present invention.

In FIG. 5, in the disaster-preventing device 10 of the present embodiment, the fire detecting unit 12 and the aerosol generating unit 14 are separated from each other as independent units. The fire detecting unit 12 is similar to that of the embodiment of FIGS. 1A and 1B. The aerosol generating unit 14 is also basically the same as that of the embodiment shown in FIG. 1A to FIG. 4. A cover 58 is attached to the left side of the outer container 42, in which the discharging openings 30 are formed in its periphery; and, as shown in FIG. 5, the signal line 15 extended from back of the fire detecting unit 12 is attachably/detachably connected by a connector 25 to apart that is approximately the center thereof.

Since the fire detecting unit 12 and the aerosol generating unit 14 are separated from each other in this manner, the effect of extinguishment can be enhanced, for example, by installing the fire detecting unit 12 at a position such as a ceiling surface in a device board where smoke can be easily detected, while disposing the aerosol generating unit 14, for example, in the vicinity of power-supply equipment which may serve as the source of fire occurrence in the device board.

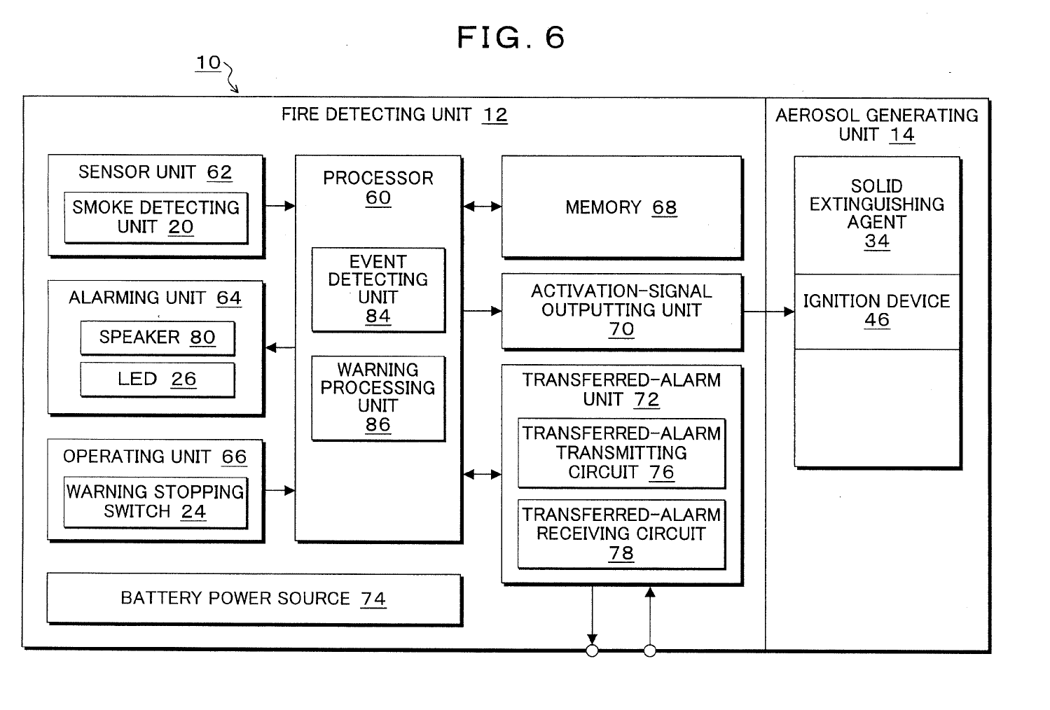

FIG. 6 is a block diagram showing a functional configuration of the disaster-preventing device of a standalone-type according to the present invention. In FIG. 6, the fire detecting unit 12 is provided with a processor 60 known as a one-chip CPU; and, with respect to the processor 60, a sensor unit 62, an alarming unit 64, an operating unit 66, a memory 68, an activation-signal outputting unit 70, a transferred-alarm unit 72, and a battery power source 74 are provided. In the sensor unit 62, the smoke detecting unit 20, which detects smoke and outputs a signal, is provided. As described above, in the sensor unit 62, instead of the smoke detecting unit 20, a temperature detecting element such as a thermistor which detects temperature or temperature change or various elements which detect other phenomenon change accompanying fire may be provided. A speaker 80, which outputs warning sound or the like, and the LED 26, which displays warning or the like, are provided in the alarming unit 64.

The speaker 80 outputs alarming sound such as a sound message or warning sound from a sound-synthesizing circuit unit, which is not shown, via an amplifying unit, which is not shown. The LED 26 indicates a problem or the like such as fire by blinking, flickering, lighting, etc. A buzzer may be used instead of the speaker 80. Instead of the LED 26, a two-color LED, a liquid crystal display device, or the like may be provided. As a matter of course, the LED, the liquid crystal display device, etc. may be provided in combination.

The warning stopping switch 24 is provided in the operating unit 66. The warning stopping switch 24 functions either as a warning stopping switch or an inspection switch in accordance with the operating state of the fire detecting unit 12 at the point of operation of the switch. The activation-signal outputting unit 70 outputs the activation signal to the ignition device 46 provided in the aerosol generating unit 14 to distribute power and heat the heater coil and ignite and combust the solid extinguishing agent 34, thereby discharging the aerosol. The transferred-alarm unit 72 is provided with a transferred-alarm transmitting circuit 76 and a transferred-alarm receiving circuit 78. The transferred-alarm transmitting circuit 76 outputs a transferred-alarm signal via a signal line to various external devices upon detection of fire to cause them to carry out cooperative operation, and the transferred-alarm signal is, for example, a dry contact signal. The transferred-alarm receiving circuit 78 receives transferred-alarm signals from various external devices via signal lines and enables cooperative operation. Herein, the activation-signal outputting unit 70 may be a transferred-alarm transmitting circuit which outputs a wet signal.

The battery power source 74 uses, for example, a predetermined number of cells of lithium batteries or alkaline dry batteries, wherein, for example, a battery life of ten years is ensured by reducing the electric power consumption of the entire circuit unit in the fire detecting unit 12. In the present embodiment, a current is supplied to the ignition device 46 of the aerosol extinguishing device 14 by using the battery power source of the fire detecting unit 12 to carry out power distribution and ignition. However, a battery dedicated to ignition may be provided in the aerosol generating unit 14 so as to distribute power to and ignite the ignition device 46 from the ignition-dedicated battery according to an activation signal (for example, wet contact signal) from the activation-signal outputting unit 70. In the processor 60, functions of an event detecting unit 84 and a warning processing unit 86 are provided as the functions realized by execution of a program(s). The event detecting unit 84 detects whether fire has been detected or not, whether recovery from fire has been made or not, and events of its own device including operation inputs made by the operating unit 66 for, for example, stop warning. When the event detecting unit 84 detects fire based on a smoke detection signal from the sensor unit 62, the warning processing unit 86 outputs an activation signal (causes an activation current to flow) from the activation-signal outputting unit 70 to the ignition device 46 of the aerosol generating unit 14 to distribute power to heat the heater coil 48 and ignite and combust the solid extinguishing agent 34, thereby discharging the aerosol. Moreover, when the event detecting unit 84 detects fire based on the smoke detection signal from the sensor unit 62, the warning processing unit 86 causes the speaker 80 to output warning sound indicating fire and causes the LED 26 to carry out warning display. In detailed explanation, when the event detecting unit 84 compares the smoke detection signal from the smoke detecting unit 20 provided in the sensor unit 62 with a predetermined threshold value, wherein fire is detected since the signal exceeds the threshold value, the warning processing unit 86 repeatedly outputs warning sound such as a sound message “Woo Woo Fire Fire” from the speaker 80 of the alarming unit 64 and carries out warning display by lighting the LED 26. When the event detecting unit 84 detects operation of the warning stopping switch 24 while a fire warning is being output, the warning processing unit 86 stops output of the warning sound from the speaker 80 and the fire warning displayed by the LED 26. In this process, the warning display by the LED 26 may be stopped after continuation of a predetermined period of time after the output of the warning sound is stopped. When the event detecting unit 84 detects operation of the warning stopping switch 26 provided in the operating unit 66 in a normal monitoring state, the warning processing unit 86 executes a predetermined internal self inspection and outputs an inspection result from the alarming unit 64. Herein, the normal monitoring state refers to a state which is at least not during fire warning. If normal, as the output of the inspection result, alarming sound including a sound message such as “Normal” is output. If malfunction has been detected, alarming sound including a sound message such as “Beep, Malfunctioning” is output. Examples of the contents to be checked in an inspection process include: whether the smoke detecting unit 20 (sensor) is malfunctioning or not, whether the circuit is malfunctioning or not, whether there is a sensitivity trouble or not, and presence of other failure. In addition to them, whether there is below-explained low-battery failure or not may be checked in combination also in the inspection process. The warning processing unit 86 carries out warning when the event detecting unit 84 detects and determines low-battery failure, which is a voltage drop trouble of the battery (power source) caused along with reduction in the usable volume of the battery power source 74. In the low-battery detection and determination by the event detecting unit 84, the power supply voltage supplied from the battery power source 74 is read at a predetermined measurement time interval T3, for example, at a time interval of T3=4 hours by A/D conversion by the processor 60 via an unshown voltage detecting circuit and is compared with a predetermined threshold voltage.

If equal to or lower than the threshold voltage, low-battery is determined. If the determination of low-battery continues a predetermined number of times, low-battery failure is assertively determined. Based on this, the warning processing unit 86 repeatedly outputs failure warning sound composed of a sound message such as “Beep, No Battery” three times and blinks the LED 22 in synchronization with the warning sound. Thereafter, as a periodic ring, for example, warning sound such as “Beep, No Battery” is output, for example, every hour. When the event detecting unit 84 detects operation of the warning stopping switch 24, “Beep, No Battery” is output one time, and the LED 22 is caused to blink. This low-battery failure warning is an advance notice preannouncing battery-runout; and, even after the low-battery failure is assertively determined and the low-battery warning output is started, the fire detecting unit 12 can continue operating for, for example, 72 hours thereafter.

If battery replacement is not carried out during this period, the battery (power source) voltage is further reduced, and the processor 60 is finally reset, and operation is stopped.

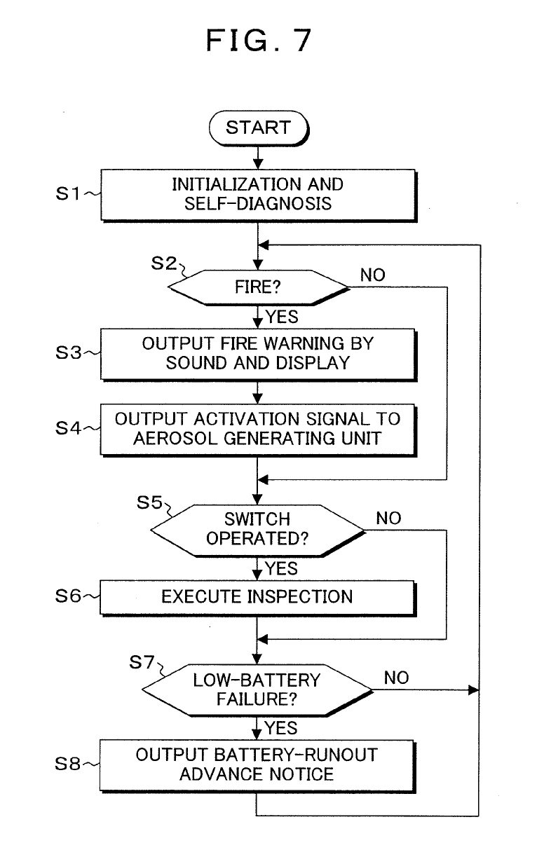

FIG. 7 is a flow chart schematically exemplifying a processing operation according to the disaster-preventing device of FIG. 6, wherein the processing operation of the processor 60 is shown. In FIG. 7, when electric power supply by the battery power source 74 of the fire detecting unit 12 is started, initialization and self-diagnosis are executed in step S1. If there is no trouble, the process proceeds to step S2, and whether there is fire detection or not is determined. If it is determined in step S2 that there is fire detection, the process proceeds to step S3, wherein fire warning is output by sound message output from the speaker 80 and warning display output by lighting the LED 26. Then, in step S4, an activation signal is output to the aerosol generating unit 14, and power is distributed to heat the heater coil 48 of the ignition device 46, thereby igniting and combusting the solid extinguishing agent 34 and starting extinguishment by discharging the aerosol. At the same time as or around the output of the fire warning in step S3, the transferred-alarm signal is output from the transferred-alarm transmitting circuit 72 of the transferred-alarm unit 72; however, illustration thereof is omitted. If an operation input of the warning stopping switch 24 is detected while the fire warning is being output in step S3, the fire warning is stopped. In step S5, whether the warning stopping switch 24 has been operated or not in the normal state in which fire warning is not being carried out. If it is determined that the switch has been operated, the process proceeds to step S6, wherein a self inspection process is executed, for example, to check whether the smoke detecting unit 20 is malfunctioning or not, whether the circuit is malfunctioning or not, whether there is a sensitivity trouble or not, and whether there is other failure or not. If malfunctioning or failure is detected, failure warning or the like is output as an inspection result. If normal as a result of the inspection, that fact is announced.

Subsequently, whether there is low-battery failure or not is periodically determined in step S7. If the low-battery failure is assertively determined, the process proceeds to step S8, wherein low-battery failure warning is output by sound message output from the speaker 80 and blinking output of the LED 26 to preannounce battery-runout. If the voltage of the battery continues reducing, as described above, for example, warning sound such as “Beep, No Battery” is output once in every minute or every hour as a periodical ring.

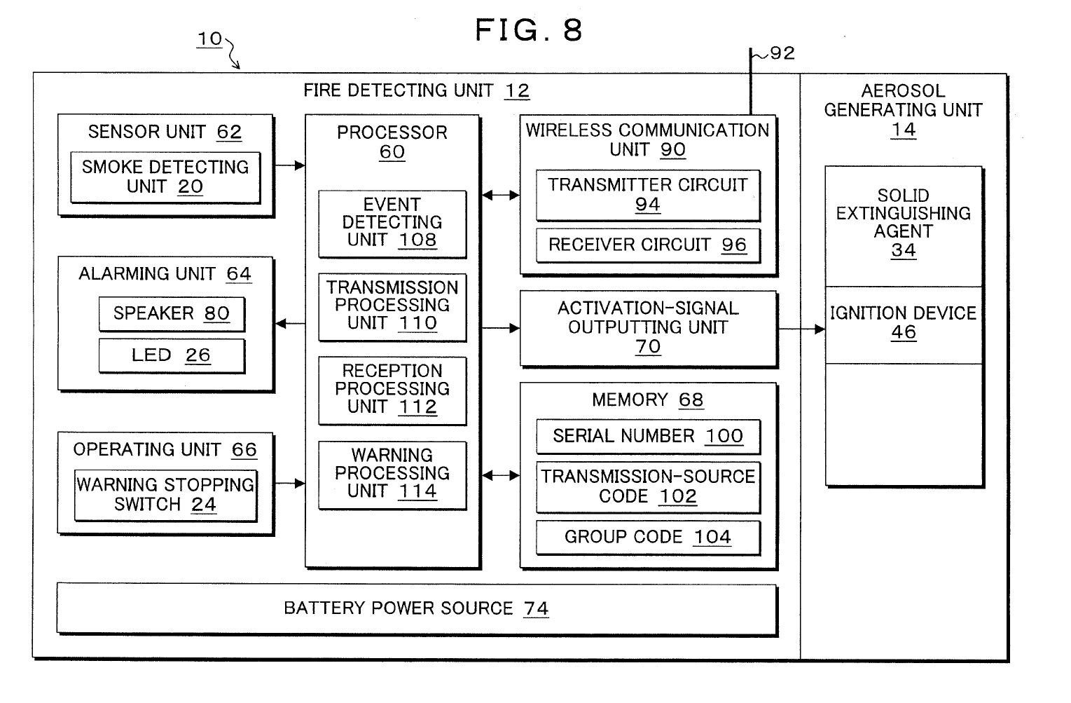

FIG. 8 is a block diagram showing a functional configuration of the disaster-preventing device of a wireless-cooperation type according to the present invention. In FIG. 8, a fire detecting unit 12 of the disaster-preventing device 10 is basically similar to the fire detecting unit 12 of the embodiment of FIG. 6, a wireless communication unit 90 provided with an antenna 92 is further provided, a transmission processing unit 110 and a reception processing unit 112 are accordingly provided in the processor 60. A transmitter circuit 94 and a receiver circuit 96 are provided in the wireless communication unit 90 so that event signals (cooperation signals) can be wirelessly transmitted/received to/from other disaster-preventing devices. In order to obtain good wireless communication conditions, the antenna 92 may be installed so as to be exposed to outside of the device board, or, for example, the fire detecting device 12 and the wireless communication unit 90 may be separated from each other. In the case of inside of Japan, as the wireless communication unit 90, a configuration based on, for example, STD-30 (wireless equipment standard of low power security system wireless stations) known as a standard of specified low power wireless stations of 400 MHz band or STD-T67 (standard of wireless equipment for specified low power wireless station telemeter, for telecontrol, and for data transmission) is provided. As a matter of course, at the location outside of Japan, as the wireless communication unit 90, contents based on a standard of allocated wireless stations of that area are provided. The memory 68 serving as a storage unit stores: serial numbers 100, which are consecutive numbers showing the order of event signals; a transmission-source code 102, which serves as an ID (identifier of its own device) specifying each disaster-preventing device; and a group code 104 for constituting a cooperation group. The serial numbers 100 are for managing relay processes, etc. of the event signals particularly in wireless communication between extinguishing devices. However, detailed explanation thereof will be omitted since the serial numbers are not directly related to the present invention. As the transmission-source code 102, for example, a multiple-bit code of, for example, about 26 bits is used so that the code is not redundant with any other disaster-preventing devices provided within the country, wherein, for example, a serial number or the like of the disaster-preventing device is utilized. The group code 104 is a code commonly set for a plurality of disaster-preventing devices which constitute a cooperation group. When the group code contained in an event signal received by the receiver circuit 96 of the wireless communication unit 90 from another disaster-preventing device matches the group code 104 registered in the memory 68 of its own device, this event signal is processed as a valid signal.

Therefore, unnecessary cooperation with disaster-preventing devices belonging to another group which is not required to be cooperated can be avoided. The group code 104 is not necessarily the same code for the disaster-preventing devices which belong to the same group, as long as the group to which its own device belongs and the group to which other disaster-preventing devices belong are the same or not can be determined by carrying out, for example, computation based on the codes. The sensor unit 62, the alarming unit 64, the operating unit 66, the activation-signal outputting unit 70, and the battery power source 74 provided in the fire detecting unit 12 are the same as those of the embodiment of FIG. 6. The transferred-alarm unit 72 is omitted in the embodiment of FIG. 8; however, the transferred-alarm unit 72 can be provided as well as the embodiment of FIG. 6. As the functions realized by execution of a program(s), functions of an event detecting unit 108, a transmission processing unit 110, a reception processing unit 112, and warning processing unit 114 are provided in the processor 60. The event detecting unit 108 detects events as well as the event detecting unit 84 of FIG. 6. The event detecting unit 108 also detects event contents obtained as decoding results of the event signals received from other disaster-preventing devices via the reception processing unit 112 (hereinafter, the decoding to the event contents detection are sometimes inclusively referred to as “reception”). When the event detecting unit 108 detects an event of its own device such as fire detection, warning stopping operation input, or fire recovery, the transmission processing unit 110 transmits an event signal corresponding to the detected event from the transmitter circuit 94 of the wireless communication unit 90 to the disaster-preventing device(s) of a cooperation destination(s). The reception processing unit 112 receives event signals from the other disaster-preventing devices via the receiver circuit 96 of the wireless communication unit 90 and decodes the event signals. When the event detecting unit 108 detects fire, the warning processing unit 114 causes the speaker 80 to output warning sound indicating a cooperation origin, causes the LED 26 to undergo, for example, lighting activation to carry out warning display indicating the cooperation origin (fire detection origin), and further transmits an event signal indicating the fire to the other disaster-preventing devices.

In specific explanation, when the event detecting unit 108 detects fire based on a smoke detection signal of the smoke detecting unit 20 provided in the sensor unit 62, the warning processing unit 114 carries out alarming by repeatedly outputting fire warning sound such as a sound message “Woo Woo Fire Fire” indicating the cooperation origin from the speaker 80 of the alarming unit 64, lights the LED 26 to carry out warning display indicating the cooperation origin, and further causes the transmitter circuit 94 of the wireless communication unit 90 to transmit an event signal indicating the fire from the antenna 92 to the other disaster-preventing devices via the transmission processing unit 110. Also, when the receiver circuit 96 of the wireless communication unit 90 receives an event signal indicating fire from the other disaster-preventing device and when the decoding result thereof in the reception processing unit 112 is valid, the warning processing unit 114 carries out alarming by causing the speaker 80 of the alarming unit 64 to repeatedly output fire warning sound indicating the cooperation destination such as a sound message “Woo Woo, another fire warning device has been activated. Please confirm.” based on the event contents detected by the event detecting unit 108 and, at the same time, blinks the LED 26 to carry out warning display indicating a cooperation destination. Also, the warning processing unit 114 carries out alarm outputting control and processing accompanying malfunction or failure detection and low-battery failure assertive determination by the event detecting unit 108. Details of the sensor failure detection and low-battery failure detection are the same as those of the embodiment of FIG. 6. Also, the warning processing unit 114 carries out cooperation control and processing not only about fire events, but also about other events in accordance with needs.

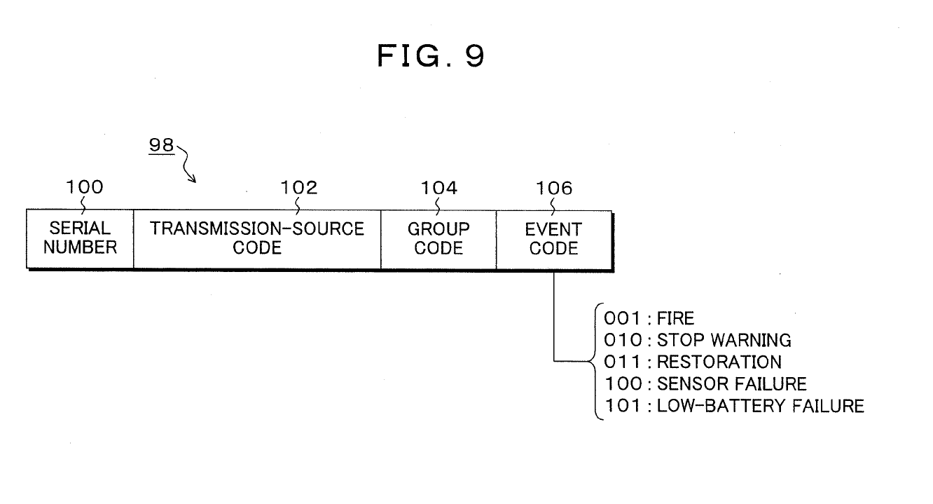

FIG. 9 is an explanatory drawing showing a format of the event signal used in the cooperation in the embodiment of FIG. 8. In FIG. 9, an event signal 98 is composed of the serial number 100, the transmission-source code 102, the group code 104, and an event code 106. The serial number 100 is a consecutive number indicating the order of the event signal and is increased by one every time the event signal is transmitted. The serial number 100 is asynchronously generated in each of the disaster-preventing devices. The serial number 100 is for managing relay processing, etc. of the event signal mainly in wireless communication; however, detailed explanation thereof will be omitted since the serial number is not directly related to the present invention. The transmission-source code 102 is, for example, a code of 26 bits. The group code 104 is, for example, a code of 8 bits, and, for example, the same group code is set for a plurality of disaster-preventing devices constituting the same group. The event code 106 is a code indicating the content of the event such as fire, a 3-bit code is used in the present embodiment, and the event code is, for example:
001=Fire,
010=Stop Warning,
011=Recovery,
100=Sensor Failure (malfunction),
101=Low-battery failure.
   Herein, 000 is used, for example, in periodic report of wireless communication that does not involve event detection.

Furthermore, more event contents can be represented by increasing the bit number of the event code 106 to 4 bits or 5 bits. For example, the event codes of recovery may be separated that of fire recovery and that of failure recovery.

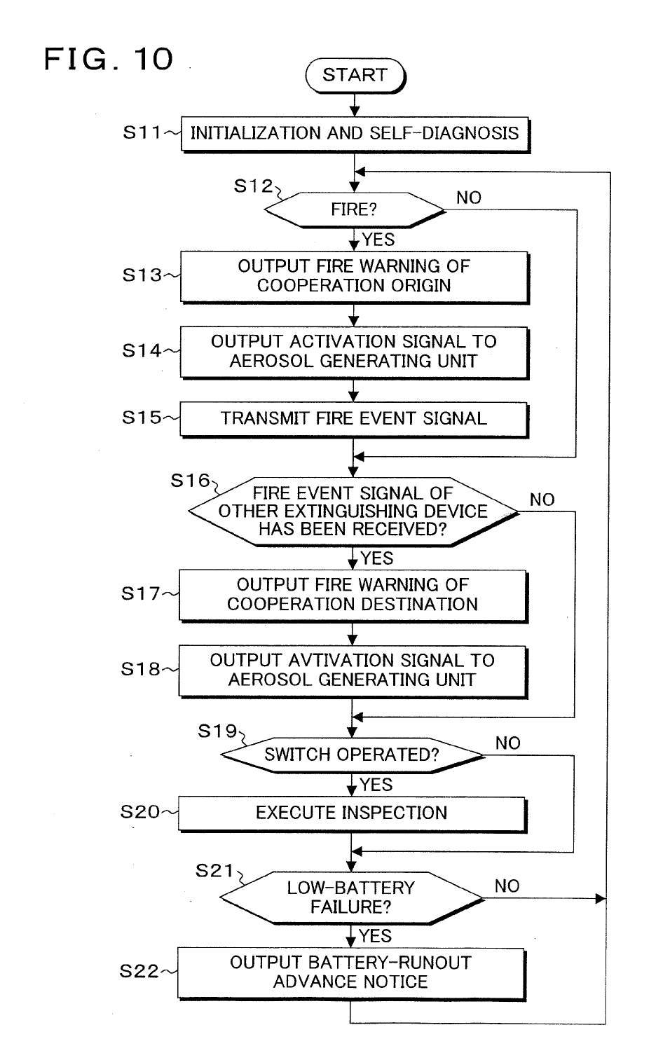

FIG. 10 is a flow chart showing a processing operation by the disaster-preventing device of FIG. 8, wherein the processing operation of the processor 60 is shown. In FIG. 10, steps S11 to S14 and steps S19 to S22 are basically the same as steps S1 to S4 and S5 to S8 of the processing operation in the embodiment of FIG. 6 shown in FIG. 7. However, in step S13, fire warning output is that of a cooperation origin. As fire detection is determined in step S12, the event signal including the serial number, transmission-source code, group code, and event code indicating fire is transmitted to the other disaster-preventing device(s) in step S15. Subsequently, in step S16, whether an event signal indicating fire has been received or not from the other disaster-preventing device is determined. If reception of the event signal indicating fire is determined (YES), the process proceeds to step S17, wherein fire warning of a cooperation destination is output by sound message output from the speaker 80 and warning display output by blinking of the LED 26. Then, in step S18, the activation signal is output to the aerosol generating unit 14 to distribute power to heat the heater coil 48 of the ignition device 46, thereby igniting and combusting the solid extinguishing agent 34 to start extinguishment by discharging the aerosol. When operation input of the warning stopping switch 24 of its own device is detected while the fire warning is output in step S13 or S17, the fire warning is stopped. An event other than fire can be arbitrarily subjected to cooperation.

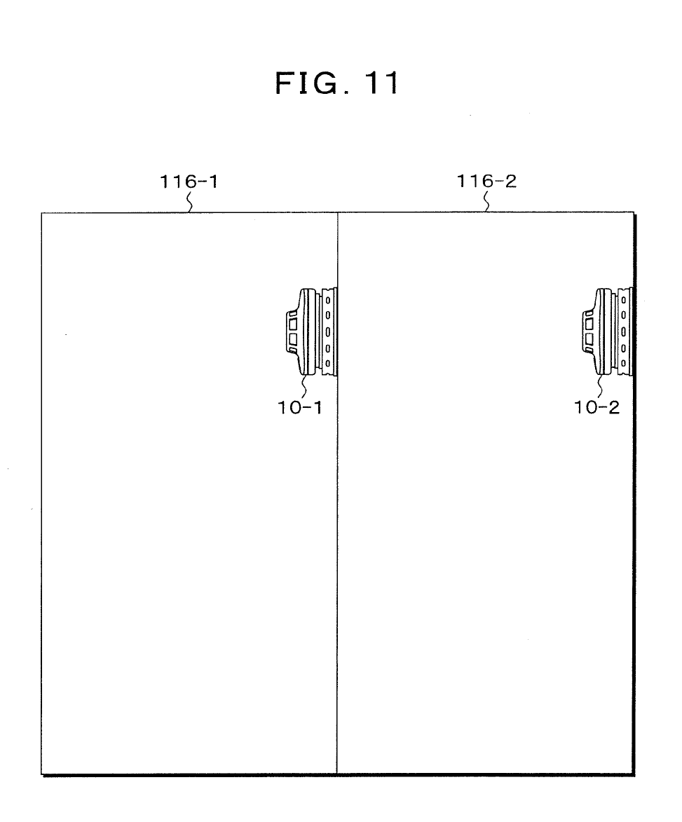

FIG. 11 is an explanatory drawing showing an installation example in which each of extinguishing devices of the standalone-type shown in FIG. 6 is installed for each of device boards. In FIG. 11, disaster-preventing devices 10-1 and 10-2 are installed in the boards of the device boards 116-1 and 116-2. In this case, the disaster-preventing devices 10-1 and 10-2 are installed in the device boards 116-1 and 116-2, respectively. However, in the case in which the weight of the solid extinguishing agent housed in the disaster-preventing devices 10-1 and 10-2 with respect to the board-interior volume is small, devices may be arbitrarily added, for example, two extinguishing devices are installed for each of the boards 116-1 and 116-2 so as to correspond to the board-interior volume. In that case, a plurality of aerosol generating units 14 may be connected, for example, in series to the activation-signal outputting unit provided in the fire detecting unit 12 of the disaster-preventing device. The connection method may be other than this one as long as the connection method enables the heater coil 48 of each of the aerosol generating units to ignite the solid extinguishing agent 34 without problem according to an activation signal.

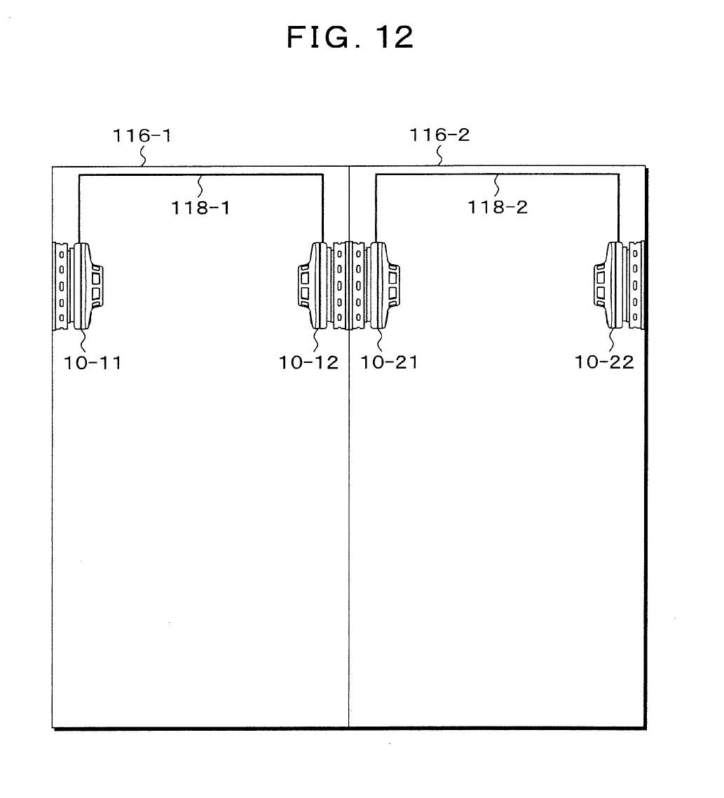

FIG. 12 is an explanatory drawing showing an installation example in which two extinguishing devices of the standalone-type of FIG. 6 are installed for each of device boards. In FIG. 12, disaster-preventing devices 10-11 and 10-12 are installed in the board of the device board 116-1, and disaster-preventing devices 10-21 and 10-22 are installed in the board of the device board 116-2. The disaster-preventing devices 10-11 and 10-12 of the device board 116-1 are connected by a pair of transferred-alarm signal lines 18-1 (transferred-alarm transmission, transferred-alarm reception); and the disaster-preventing devices 10-21 and 10-22 of the device board 116-2 are similarly connected by a pair of transferred-alarm signal lines 118-2; wherein transferred-alarm signals indicating fire can be mutually transmitted/received if fire is detected.

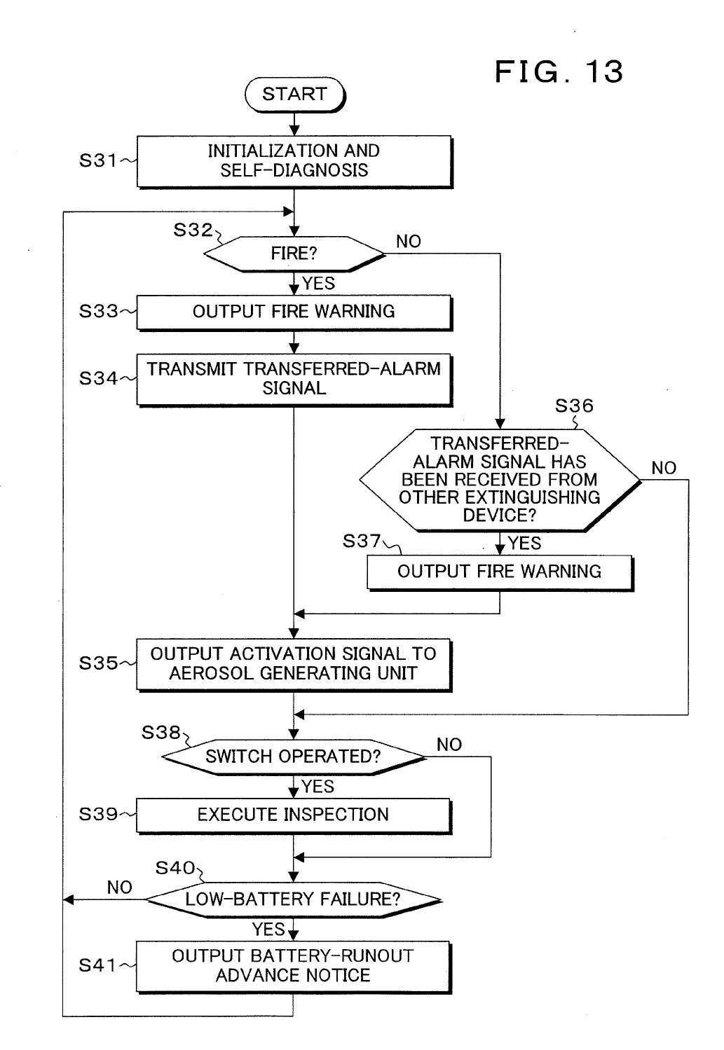

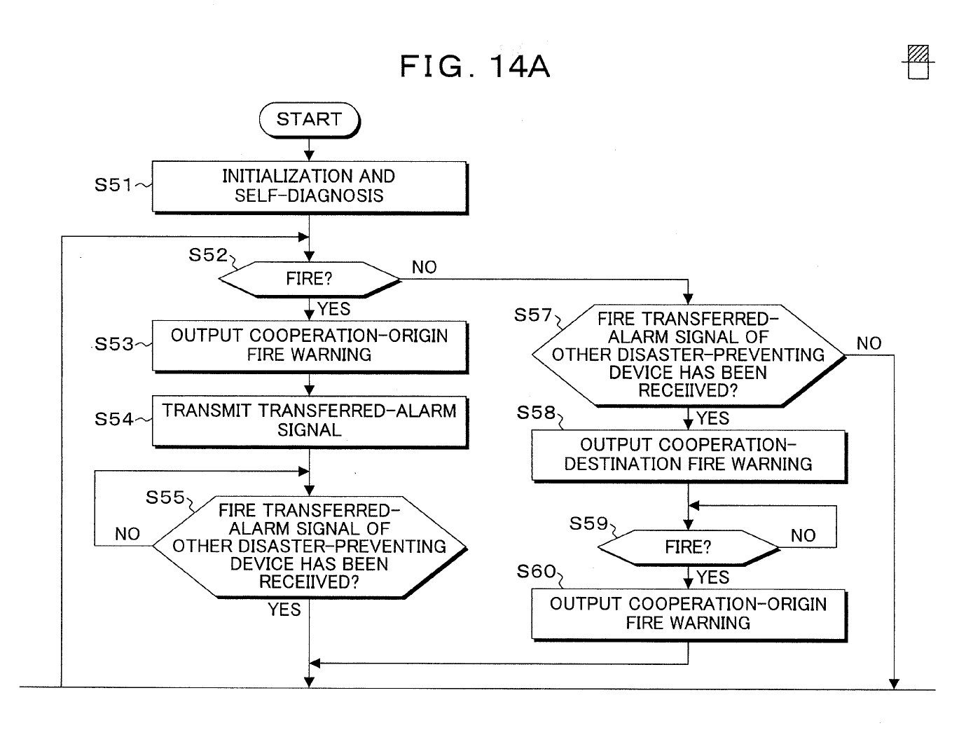

FIG. 13 is a flow chart showing an OR linked processing operation according to the transferred-alarm signal with respect to the installation example of FIG. 12. Herein, the OR linked processing operation refers to an operation in which, according to reception of the transferred-alarm signal indicating fire from the other disaster-preventing device, the device of its own discharges the aerosol in cooperation. In other words, this is the case in which, when fire is detected by the fire detecting unit 12 of either one of the disaster-preventing devices, the aerosol generating unit of the other disaster-preventing device is also configured to activate. In FIG. 13, steps S31 to S33, S35, and S38 to S41 are basically the same as steps S1 to S3, S4, and S5 to S8 of FIG. 7. If fire detection is not determined in step S32, the process proceeds to step S36, wherein whether the transferred-alarm signal indicating fire has been received from the other disaster-preventing device or not is determined. If the reception of the transferred-alarm signal indicating fire is determined, fire warning is output in step S37; and the process then proceeds to step S35, wherein the activation signal is output to the aerosol generating unit 14 of its own device, and power is distributed to heat the heater coil 48 of the ignition device 46, thereby igniting and combusting the solid extinguishing agent 34 and starting extinguishment by discharging the aerosol in cooperation with the other disaster-preventing device.

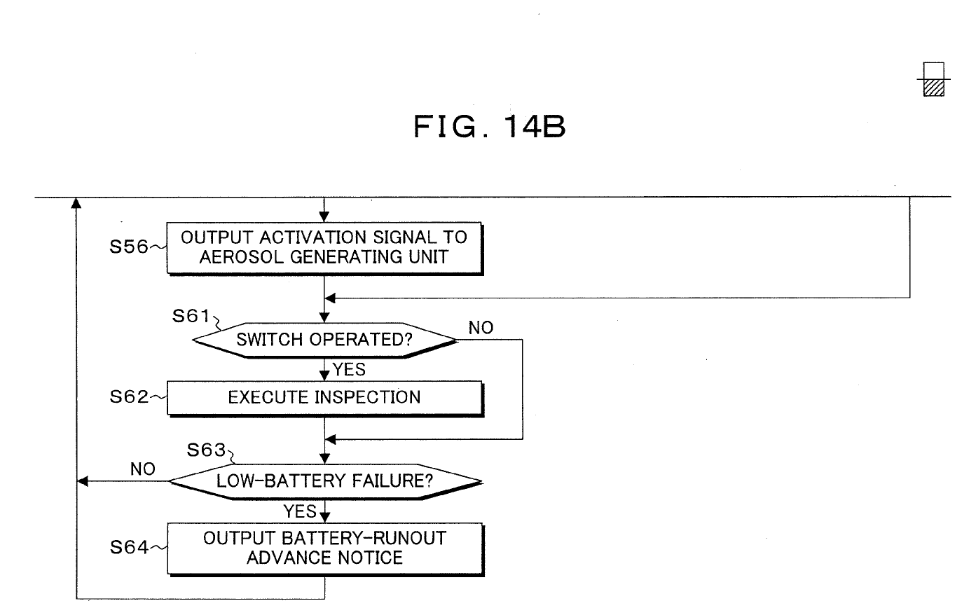

FIGS. 14A and 14B are flow charts showing an AND linked processing operation with respect to the installation example of FIG. 12. Herein, the AND linked processing operation refers to an operation in which, when reception of the transferred-alarm signal indicating fire from the other extinguishing device is determined, the aerosol generating unit 14 is activated on the condition of fire detection of its own device to discharge the aerosol. In FIGS. 14A and 14B, when electric power supply by the battery power source 74 of the fire detecting unit 12 is started, initialization and self-diagnosis are executed in step S51. If there is no trouble, the process proceeds to step S52, wherein whether there is fire detection or not is determined. If fire detection is determined in step S52, the process proceeds to step S53, wherein fire warning of a cooperation origin is output by the sound message from the speaker 80 and the warning display by lighting the LED 26. Then, in step S54, the transferred-alarm signal indicating fire is output to the other extinguishing device via the transferred-alarm signal line. Subsequently, in step S55, whether the transferred-alarm signal indicating fire has been received from the other extinguishing device or not is determined. If the reception of the transferred-alarm signal indicating fire is determined, the AND conditions are satisfied; therefore, the process proceeds to step S56, wherein the activation signal is output to the aerosol generating unit 14, the solid extinguishing agent 34 is ignited and combusted by power distribution and heating of the ignition device 46, and extinguishment by discharging the aerosol is started.

On the other hand, if fire detection is not determined in step S52, the process proceeds to step S57, wherein whether the transferred-alarm signal indicating fire has been received from the other extinguishing device or not is determined.

If the reception of the transferred-alarm signal indicating fire is determined, the process proceeds to step S58, wherein fire warning indicating a cooperation destination is output. Subsequently, in step S59, whether an event of its own device indicating fire has been detected or not is determined. If the detection of the event indicating fire is determined, the AND conditions are satisfied; therefore, fire warning of a cooperation origin is output in step S60. Then, the process proceeds to step S56, wherein the activation signal is output to the aerosol generating unit 14, the solid extinguishing agent 34 is ignited and combusted by power distribution and heating of the ignition device 46, and extinguishment by discharging of the aerosol is started. In step S61, whether the warning stopping switch 24 has been operated or not in the normal state in which fire warning is not carried out. If the switch operation is determined, the process proceeds to step S62, wherein an inspection process about, for example, whether the smoke detecting unit 20 is malfunctioning or not, whether the circuit is malfunctioning or not, whether there is a sensitivity trouble or not, and whether there is other failure or not is executed. If failure is detected, failure warning is output as a result of the inspection.

Subsequently, in step S63, whether there is low-battery failure or not is determined. If the low-battery failure is determined, the process proceeds to step S64, wherein battery-runout is preannounced by a sound message from the speaker 80 and blinking of the LED 26. In the AND linked processing operation as described above, the aerosol is discharged on the condition that fire has been detected by both of the two extinguishing devices installed in the same board; therefore, discharge of the aerosol caused by erroneous detection or erroneous operation of the fire detecting unit can be prevented.

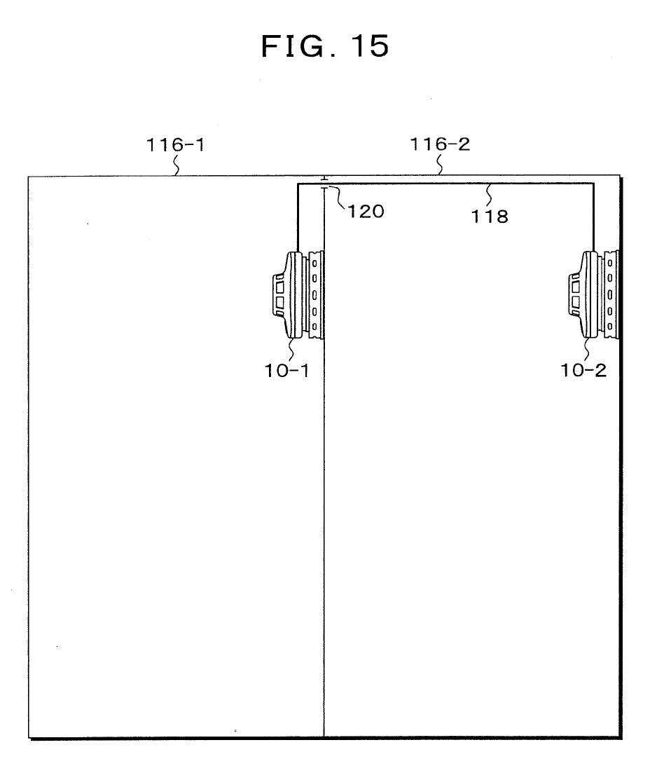

FIG. 15 is an explanatory drawing showing an installation example in which disaster-preventing devices of the standalone-type of FIG. 6 are installed in mutually adjacent device boards and connected to each other by transferred-alarm signal lines. In FIG. 15, extinguishing devices 10-1 and 10-2 are disposed in the device boards 116-1 and 116-2, respectively, a line through hole 120 is formed in a board surface serving as a boundary to connect them by the pair of transferred-alarm signal lines 118 so that transferred-alarm signals can be transmitted/received to/from each other. In the installation example of FIG. 15, either one of the OR linked processing operation shown in the flow chart of FIG. 13 and the AND linked processing operation shown in the flow charts of FIGS. 14A and 14B can be employed.

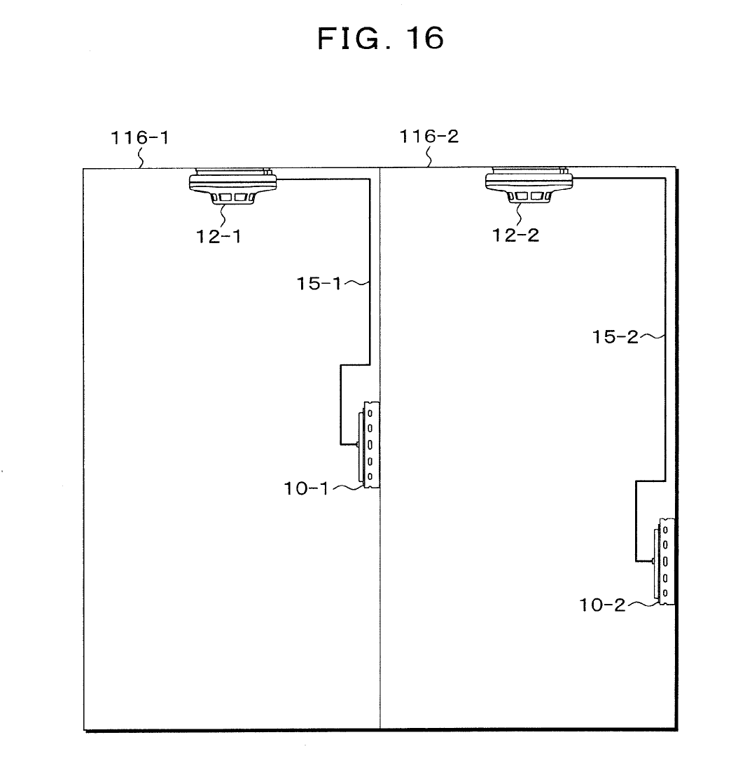

FIG. 16 is an explanatory drawing showing an installation example of separated-type disaster-preventing devices. In FIG. 16, the separated-type disaster-preventing devices are installed in the device boards 116-1 and 116-2, respectively. In the present installation example, fire detecting units 12-1 and 12-2 are installed on ceiling positions in the board which are suitable for detection of smoke caused by fire, while aerosol generating units 14-1 and 14-2 are installed in the vicinities of equipment which is at high risk to be a cause of fire occurrence according to the installation state of electric equipment in the boards 116-1 and 116-2, they are connected to each other by signal lines (activation signal lines) 15-1 and 15-2 so that output of an activation signal from one of them can activate the aerosol generating unit 14 of the other one to discharge the aerosol.

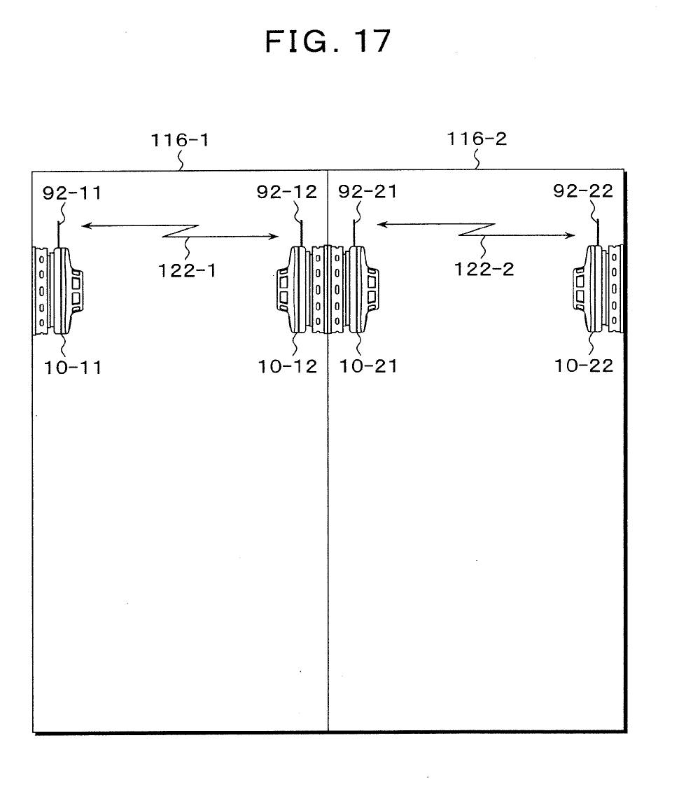

FIG. 17 is an explanatory drawing showing an installation example in which two disaster-preventing devices of the wireless-cooperation type shown in FIG. 8 are installed with respect to each of device boards.

In FIG. 17, the wireless-cooperation type disaster-preventing devices 10-11 and 10-12 provided with antennas 92-11 and 92-12 are installed in the board of the device board 116-1, and the wireless-cooperation type disaster-preventing devices 10-21 and 10-22 provided with antennas 92-11 and 92-12 are installed in the board of the device board 116-2. In the case of the wireless-cooperation type, a link using wireless lines 122-1 and 122-2 can be built; therefore, signal-line connection as shown in FIG. 12 is not required.

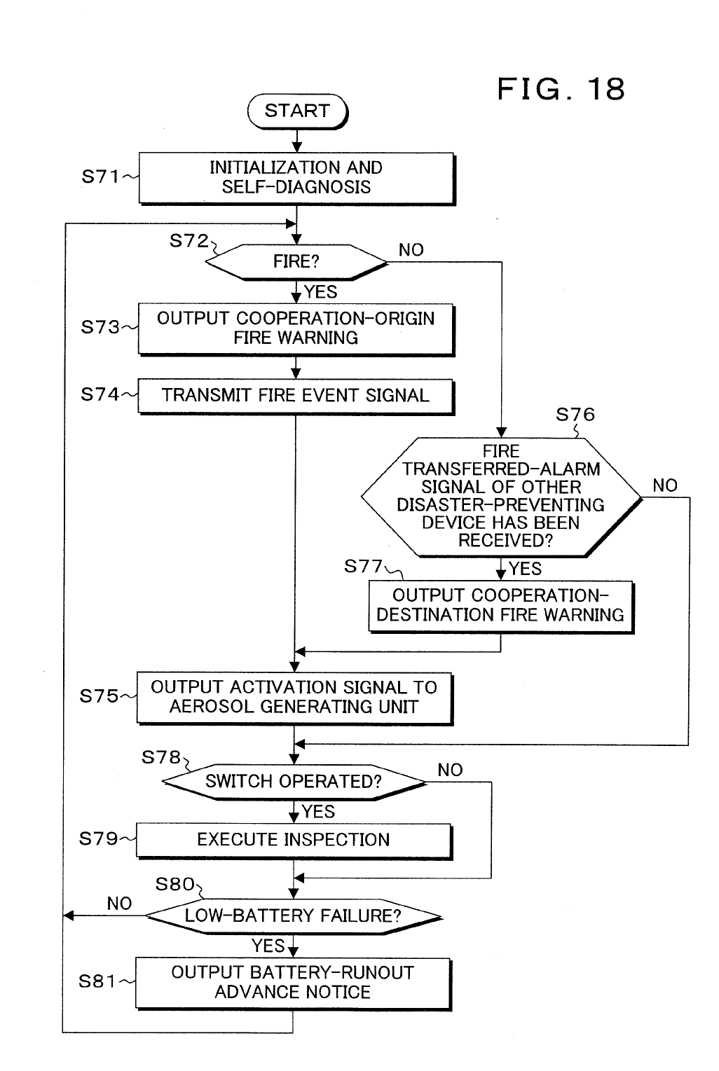

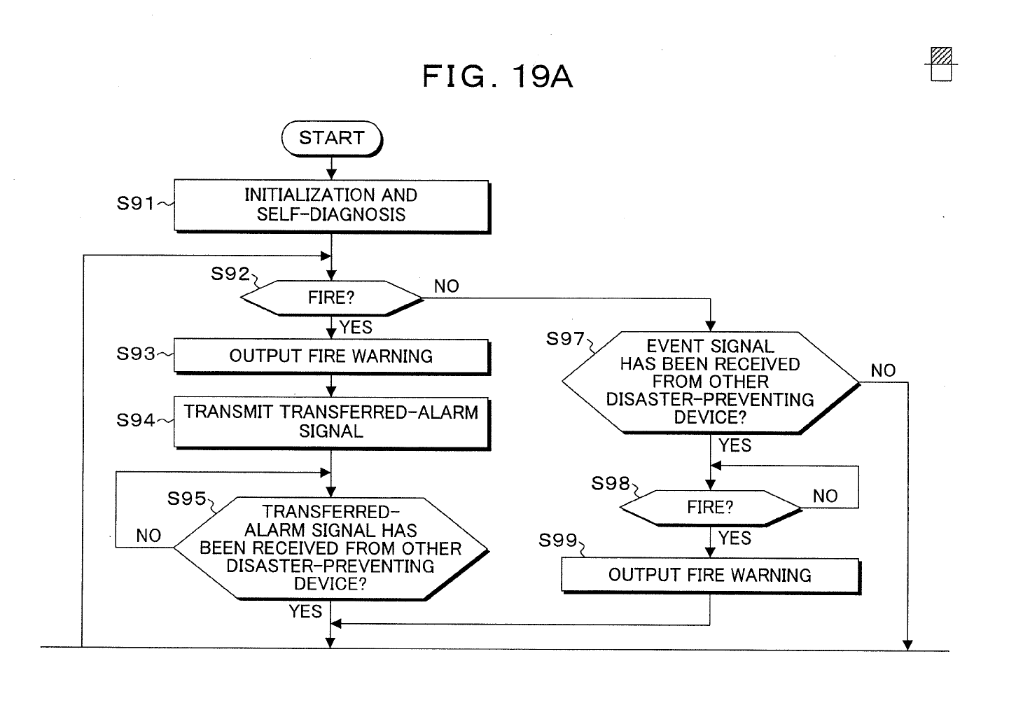

FIG. 18 is a flow chart showing an OR linked processing operation with respect to the installation example of FIG. 17. In FIG. 18, when power supply by the battery power source 74 of the fire detecting unit 12 is started, initialization and self-diagnosis are executed in step S71. If there is no trouble, the process proceeds to step S72, wherein whether there is fire detection or not is determined. If fire detection is determined (YES) in step S72, the process proceeds to step S73, wherein fire warning indicating a cooperation origin is output by sound message output from the speaker 80 and warning display output by lighting of the LED 26. Then, the event signal including the serial number, transmission-source code, group code, and event code indicating fire is wirelessly transmitted to the other disaster-preventing device.

Subsequently, in step S75, the activation signal is output to the aerosol generating unit 14, the solid extinguishing agent 34 is ignited and combusted by distributing power to heat the heater coil 48 of the ignition device 46, and extinguishment by discharge of the aerosol is started. On the other hand, if fire detection (YES) is not determined in step S72, the process proceeds to step S76, wherein whether the event signal indicating fire has been received from the other disaster-preventing device or not is determined. If the reception of the event signal indicating fire is determined (YES), the process proceeds to step S77, wherein fire warning indicating a cooperation destination is output. Then, the process proceeds to step S75, wherein the activation signal is output to the aerosol generating unit 14, and the solid extinguishing agent 34 is ignited and combusted by distributing power to heat the heater coil 48 of the ignition device 46, and extinguishment by discharge of the aerosol is started in cooperation with the other extinguishing device. Steps S78 to S80 are the same as steps S19 to S22 of FIG. 10.

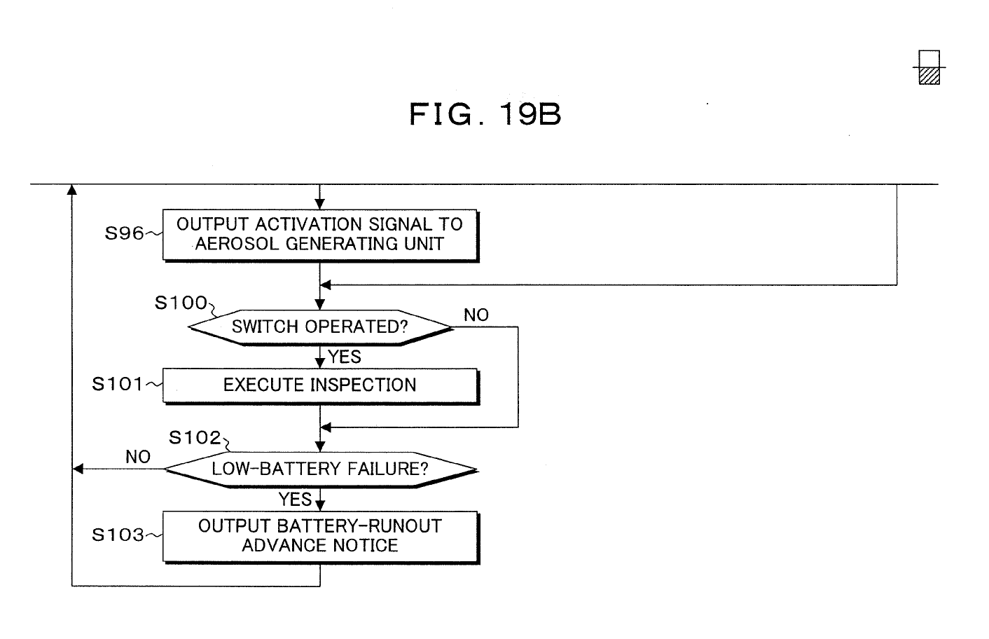

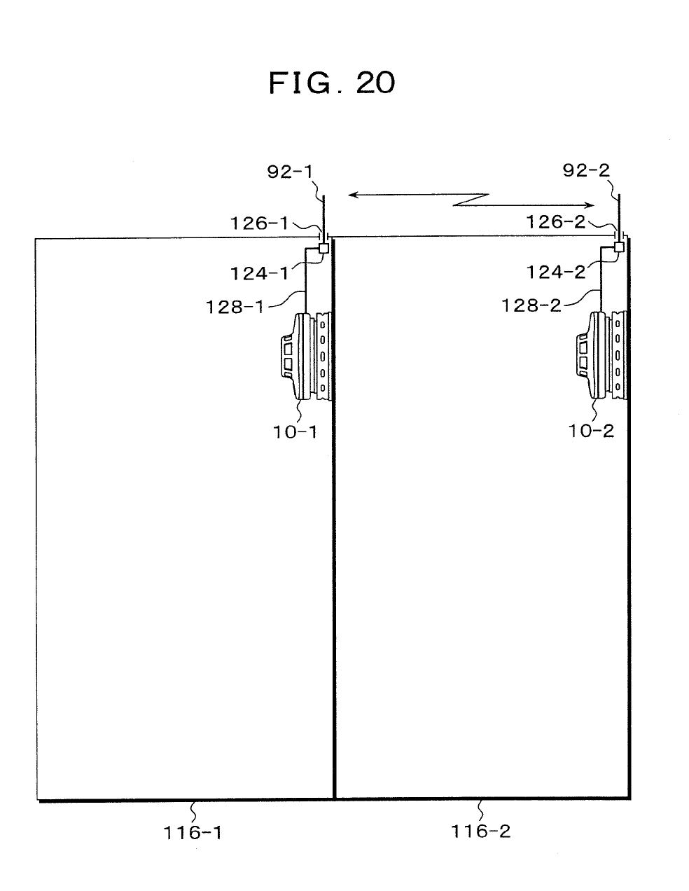

FIGS. 19A and 19B are flow charts showing an AND linked processing operation with respect to the installation example of FIG. 17. In FIGS. 19A and 19B, when power supply by the battery power source 74 of the fire detecting unit 12 is started, initialization and self-diagnosis are executed in step S91. If there is no trouble, the process proceeds to step S92, wherein whether fire has been detected or not is detected. If fire detection is determined (YES) in step S92, the process proceeds to step S93, wherein fire waning indicating a cooperation origin is output by sound message output from the speaker 80 and warning display output by lighting of the LED 26. Then, in step S94, the event signal including the serial number, transmission-source code, group code, and event code indicating fire is wirelessly transmitted to the other disaster-preventing device. Subsequently, in step S95, whether the event signal indicating fire has been received from the other disaster-preventing device or not is determined.

If reception of the event signal indicating fire is determined (YES), the AND conditions are satisfied; therefore, the process proceeds to step S96, wherein the activation signal is output to the aerosol generating unit 14, the solid extinguishing agent 34 is ignited and combusted by distributing power to heat the heater coil 48 of the ignition device 46, and extinguishment by discharge of the aerosol is started. On the other hand, if fire detection (YES) is not determined in step S92, the process proceeds to step S97, wherein the event signal indicating fire has been received from the other disaster-preventing device or not is determined. If the reception of the event signal indicating fire is determined (YES), the process proceeds to step S98, wherein whether the event of its own device indicating fire has been detected or not is determined. If detection of the event of its own device indicating fire is determined in step S98, the AND conditions are satisfied; therefore, fire warning is output in step S99. Then, the process proceeds to step S96, wherein the activation signal is output to the aerosol generating unit 14, the solid extinguishing agent 34 is ignited and combusted by distributing power to and heating the heater coil 48 of the ignition device 46, and extinguishment by discharge of the aerosol is started. Steps S100 to S103 are the same as steps S19 to S22 of FIG. 10. If reception of the event signal indicating fire from the other disaster-preventing device is determined (YES) in step S97, fire warning indicating a cooperation destination is output; and, when fire detection of its own device is determined in step S98, it is switched to output of fire warning indicating a cooperation origin. In FIGS. 18, 19A and 19B, if the warning stopping switch 24 of its own device is operated during output of fire warning, output of the fire warning is stopped regardless whether it is the cooperation origin cooperation destination.

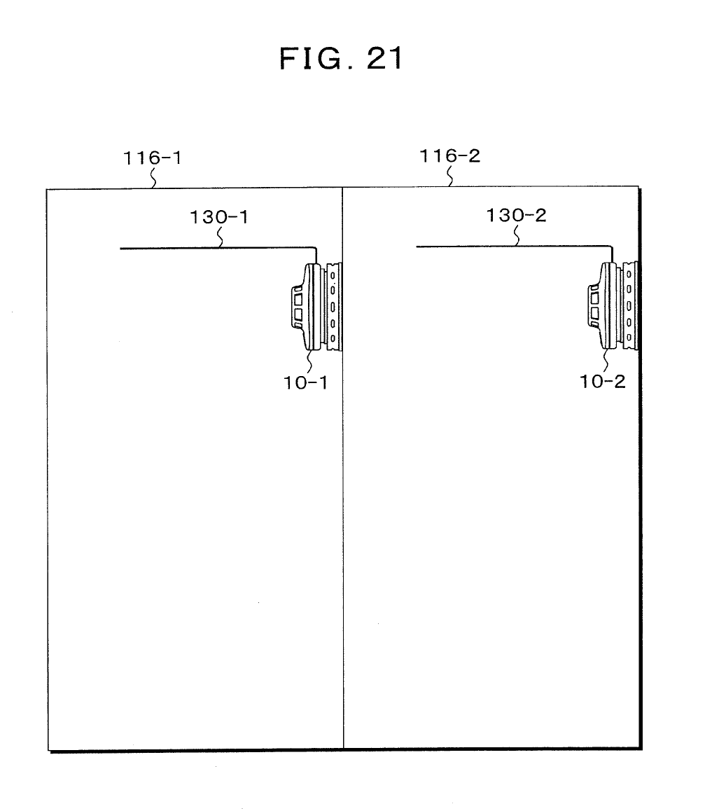

FIG. 20 is an explanatory drawing showing an installation example in which disaster-preventing devices of the wireless-cooperation type of FIG. 8 are installed in mutually adjacent device boards. In FIG. 20, the disaster-preventing devices 10-1 and 10-2 of the wireless-cooperation type are respectively installed in the device boards 116-1 and 116-2; antenna units 124-1 and 124-2 are respectively disposed inside of narrow small-diameter through holes 126-1 and 126-2 provided on ceiling surfaces of the device boards; and the antenna units respectively penetrate through the through holes 126-1 and 126-2 and are exposed to outside. The antenna units 124-1 and 124-2 are respectively connected to the disaster-preventing devices 10-1 and 10-2 by power feeding lines 128-1 and 128-2. The wireless communication units provided in the disaster-preventing devices 10-1 and 10-2 may be separated, the separated wireless communication units as a whole may be provided respectively in the antenna units 124-1 and 124-2, and signal-line connection may be established therewith. When the disaster-preventing devices 10-1 and 10-2 are installed in this manner, the disaster-preventing devices 10-1 and 10-2 installed in the device boards 116-1 and 116-2 can be linked by wireless lines using the antennas 92-1 and 92-2.

In the installation example of FIG. 20, either one of the OR linked processing operation shown in the flow chart of FIG. 18 and the AND linked processing operation shown in the flow charts of FIGS. 19A and 19B can be employed. In the present installation example, in the case in which units composed only of the fire detecting units 12 of FIG. 1 are installed and linked at radio-wave-reachable positions in, for example, a monitoring room outside of the device boards, if fire is detected by the disaster-preventing devices 10-1 and 10-2 provided in the device boards 116-1 and 116-2 to discharge the aerosol, the aerosol extinguishing operation in the device boards can be subjected to alarming by carrying out warning by wirelessly transmitting the event signals to the external fire detecting units 12.

FIG. 21 is an explanatory drawing showing an installation example of the disaster-preventing devices in which heat-sensitive cables are connected to the device boards. In FIG. 21, the disaster-preventing devices 10-1 and 10-2 are installed in the boards of the device boards 116-1 and 116-2, respectively. The heat-sensitive cables 130-1 and 130-2 are extended from the disaster-preventing devices 10-1 and 10-2 to and installed in the device boards 116-1 and 116-2 serving as monitoring areas. The heat-sensitive cables 130-1 and 130-2 may be, for example, installed around equipment which may cause overheat ignition in the device boards. Each of the heat-sensitive cables 130-1 and 130-2 is, for example, a pair of two signal lines coated with a hot-melt resin such as plastic and twisted together. Upon normal monitoring, the two signal lines are not brought into contact with each other, since the pair of two signal lines of each of the heat-sensitive cables 130-1 and 132-2 is coated to be insulated, for example, with plastic. If fire occurs, the plastic coating melts when receiving heat by the fire and reaching a predetermined temperature, and the part between the two signal lines is changed from the insulated state to a contact conducted state. The two signal lines are brought into contact with each other in this manner to be in a short-circuited state, wherein the fire can be detected by detecting the heat. If the pair of heat-sensitive cables 130 (130-1, 130-2) twisted after insulating-coating the signal lines is collectively coated with a predetermined heat-shrinking tube, the signal lines from which the insulating coating has melted and peeled off can be easily brought into contact with each other by the shrinking force of the heat-shrinking tube.

As one embodiment, regarding first fire detection based on smoke and second fire detection by the heat-sensitive cable 130-1 or 130-2, if either one of the fire detections is carried out, each of the disaster-preventing devices 10-1 and 10-2 carries out an OR activation operation of combustion of the aerosol generating unit. In another embodiment, if both of the fire detections are carried out, an AND activation operation of combustion of the aerosol generating unit is carried out.

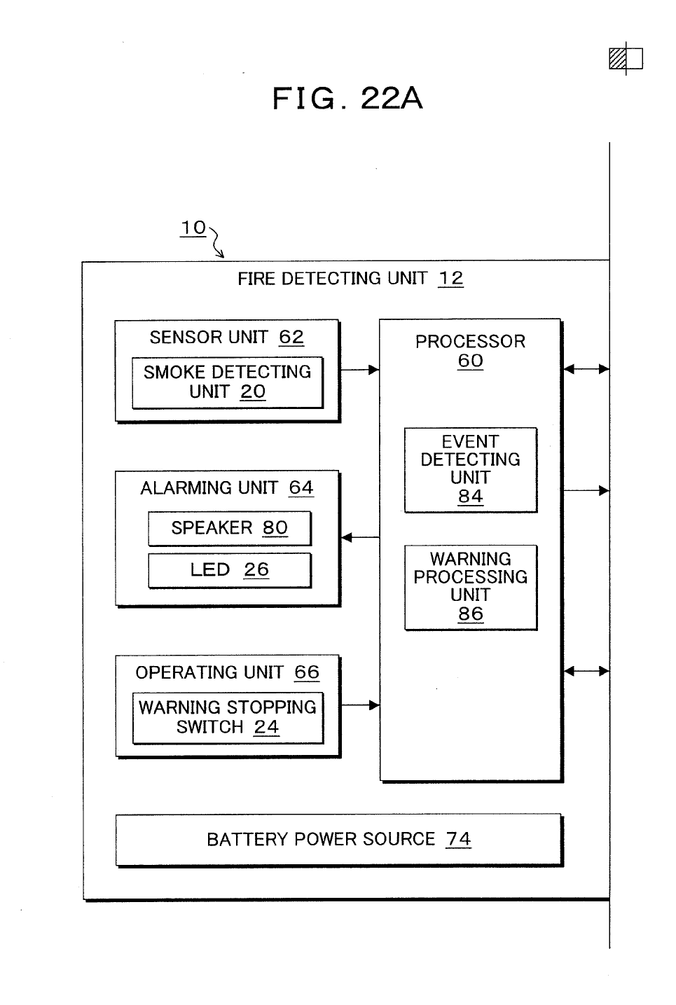

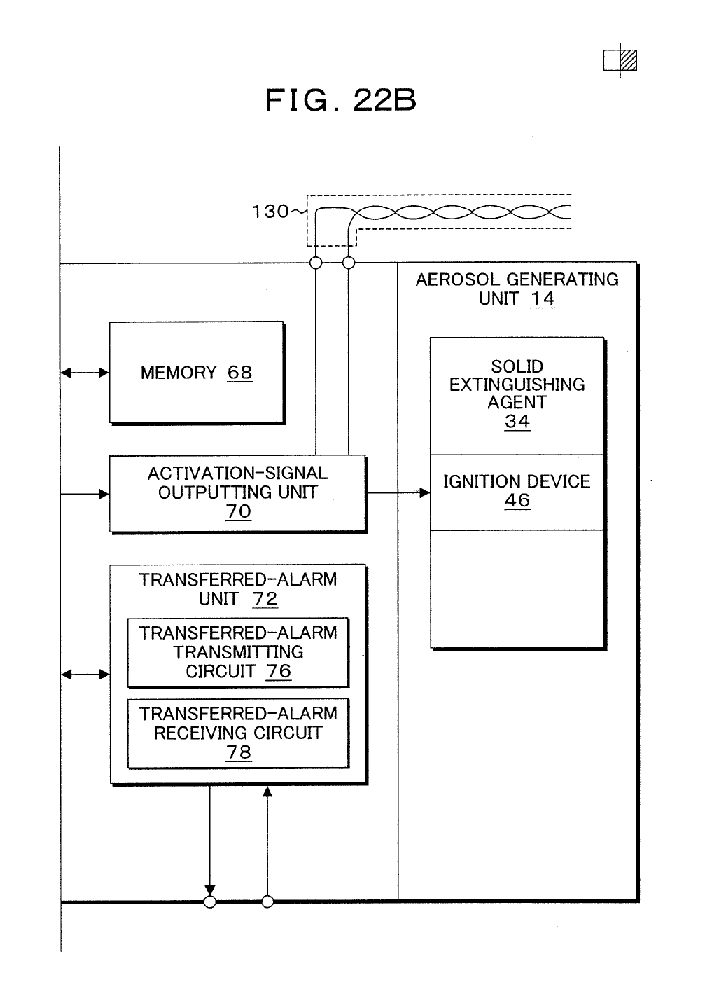

FIGS. 22A and 22B are block diagrams showing a functional configuration of the disaster-preventing device 10 (10-1, 10-2) of FIG. 21, wherein the heat-sensitive cable 130 (130-1, 130-2) is connected to the activation-signal outputting unit 70 by using heat-sensitive terminals. Configurations other than that are the same as those of the embodiment of FIG. 6 and are therefore represented by the same reference numerals.

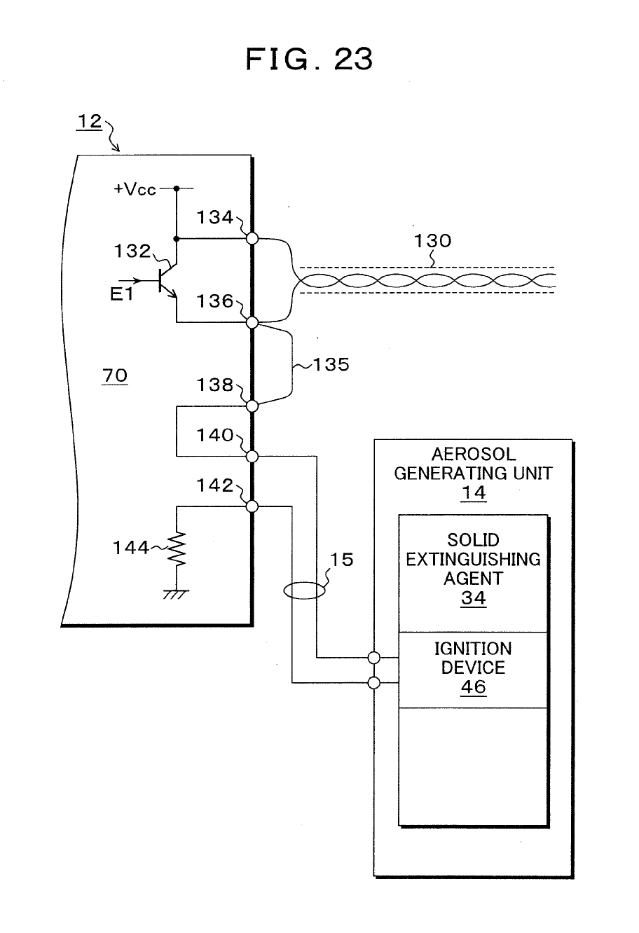

FIG. 23 is a circuit diagram exemplifying an embodiment of the activation-signal outputting unit 70 in the disaster-preventing device 10 of FIGS. 22A and 22B, which is characterized in that the OR activation operation of combustion of the aerosol generating unit is carried out if either one of the fire detections, i.e., the first fire detection based on the smoke detection signal from the smoke detecting unit 20 of the sensor unit 62 and the second fire detection by the heat-sensitive cable 130. In FIG. 23, the activation-signal outputting unit 70 provided in the fire detecting unit 12 of the disaster-preventing device 10 is provided with: heat-sensitive terminals 134, 136, and 138, which are connecting the signal lines of the heat-sensitive cable 130, and activation terminals 140 and 142, which are connecting the activation signal lines 15 to the aerosol generating unit 14. Herein, in order to carry out the OR activation operation, as shown in the drawing, ends of the two signal lines of the heat-sensitive cable 130 are respectively connected to the heat-sensitive terminals 134 and 136, and the heat-sensitive terminal 136 and the activation terminal 140 are connected to each other by a passing line 135. In the activation-signal outputting unit 70, a transistor 132 is provided as a switching element to which an activation ordering signal E1 from the warning processing unit 86 provided in the processor 60 is input if fire is detected by the event detecting unit 84 based on the smoke detection signal from the smoke detecting unit 20 of FIGS. 22A and 22B.

A collector and an emitter of the transistor 132 are respectively connected to the heat-sensitive terminals 134 and 136, and the pair of signal lines of the heat-sensitive cable 130 is connected thereto.

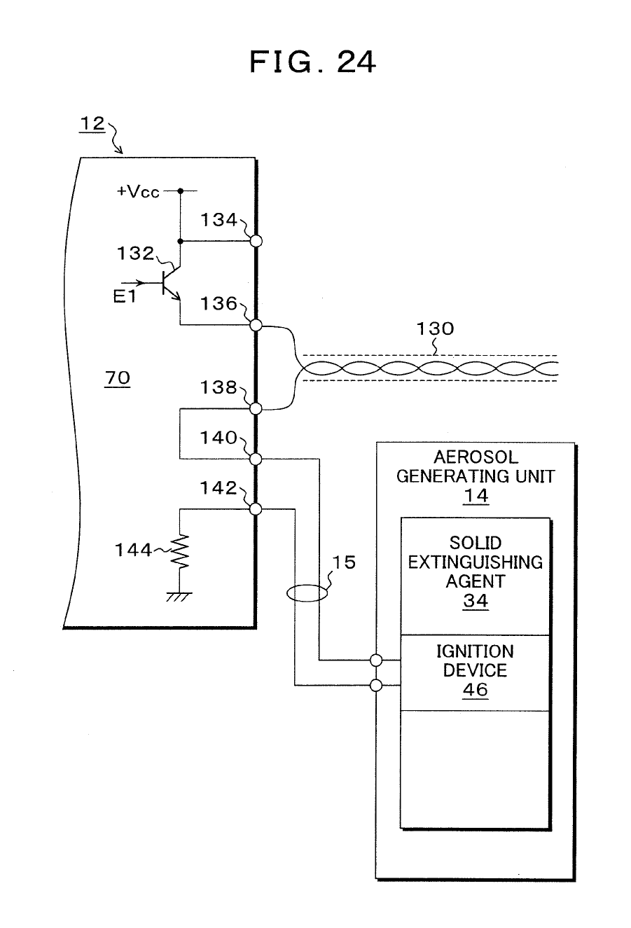

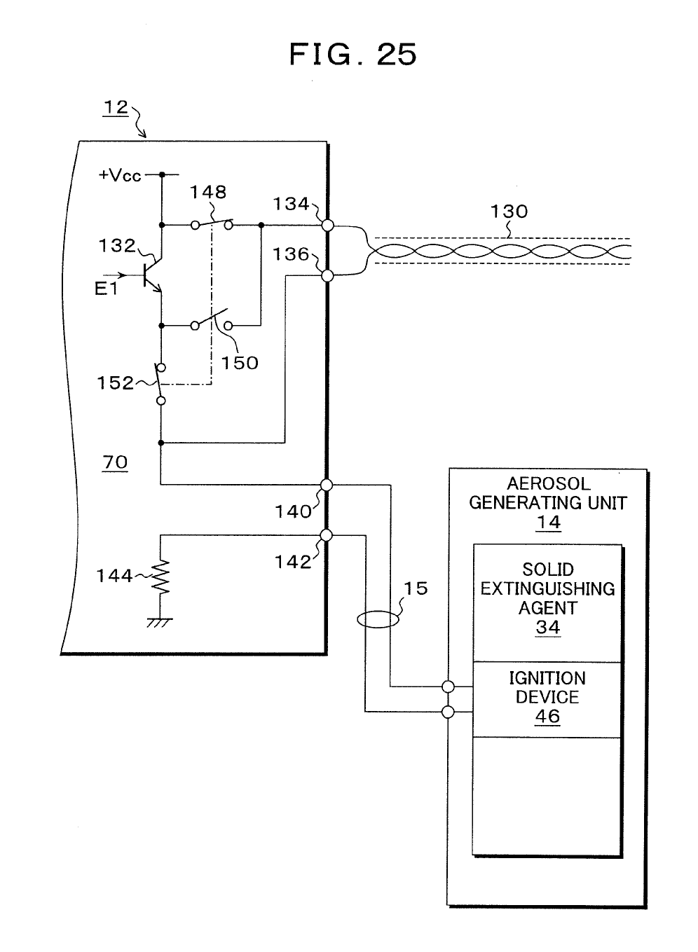

As the switching element, a relay or the like other than the transistor may be used (the same applies to later-described embodiments of FIGS. 24 to 26).

A power-supply voltage +Vcc is applied to the collector of the transistor 132, the emitter side of the transistor 132 is connected to one of the activation terminals 140 via the passing line 135, and the other activation terminal 142 is connected to the ground side via a resistance 144. The activation signal lines 15 are connected to the activation terminals 140 and 142 to connect the ignition device 46 of the solid extinguishing agent 34 housed in the aerosol generating unit 14. The resistance 144 adjusts and determines the current that flows to the ignition device 46. The OR activation operation of this case is as described below. When the event detecting unit 84 provided in the processor 60 of FIGS. 22A and 22B detects a fire detection event (fire event) by detecting fire based on the smoke detection signal from the smoke detecting unit 20; the activation ordering signal E1 is input from the warning processing unit 86 to the activation-signal outputting unit 70 to turn on the transistor 132, thereby outputting the activation signal to the activation signal lines 15, in other words, an activation current flows; and the solid extinguishing agent 34 is combusted by power distribution and heating of the ignition device 46 to discharge the aerosol. On the other hand, if the plastic, which is the insulating coating of the signal lines of the heat-sensitive cable 130, melts by receiving heat caused by fire in the device board and brings the two signal lines into contact with each other to obtain a short-circuited (conducted) state, the activation signal is output to the activation signal lines 15 via the signal lines of the heat-sensitive cable 130, which is in the short-circuited state, in other words, an activation current flows, and the solid extinguishing agent 34 is combusted by power distribution and heating of the ignition device 46 to discharge the aerosol. Therefore, in the embodiment of FIG. 23, OR activation in which the aerosol is discharged by combusting the solid extinguishing agent can be carried out also by either one of the fire detection by smoke or the fire detection by heat. Herein, when the heat-sensitive cable 130, which detects the heat caused by fire, is installed in or in the vicinity of equipment which is housed in the device board and comparatively readily serves as a source of fire occurrence, fire can be promptly detected to carryout extinguishment by the aerosol.

FIG. 24 is a circuit diagram showing another embodiment of the activation-signal outputting unit 70 in the disaster-preventing device 10 of FIGS. 22A and 22B, which is characterized in that an AND activation operation of activating the aerosol generating unit 14 is carried out when the event detecting unit 84 provided in the processor 60 of FIGS. 22A and 22B carries out fire detection of both of the first fire detection based on the smoke detection signal from the smoke detecting unit 20 and the second fire detection by the heat-sensitive cable 130.

In FIG. 24, in order to carry out the AND activation operation, the heat-sensitive terminal 134 is caused to be a vacant terminal, and the signal lines of the heat-sensitive cable 130 are connected to the heat-sensitive terminals 136 and 138 in the manner shown in the drawing. When the event detecting unit 84 provided in the processor 60 of FIGS. 22A and 22B detects fire based on the smoke detection signal from the smoke detecting unit 20, in other words, when a fire detection event (fire event) is detected, the activation ordering signal E1 from the warning processing unit 86 is input to the transistor 132 of the activation-signal outputting unit 70. The pair of signal lines of the heat-sensitive cable 130 is connected in series to the emitter side of the transistor 132 as shown in the drawing. The connection other than that is the same as that of the OR activation operation of FIG. 23. The AND activation operation of this case is as described below. When the event detecting unit 84 provided in the processor 60 of FIGS. 22A and 22B detects an event of fire detection by smoke detection by the smoke detecting unit, the activation ordering signal E1 is input from the warning processing unit 86 to the activation signal outputting unit 70, and the transistor 132 is turned on. In this state, when the plastic which is the insulating coating of the signal lines of the heat-sensitive cable 130 melts when a predetermined temperature is obtained by further receiving heat caused by the fire, the two signal lines are brought into contact with each other to obtain a short-circuited (conducted) state. Through the signal lines of the heat-sensitive cable 130 in the short-circuited state, the activation signal is output to the activation signal lines 15, in other words, an activation current flows, the solid extinguishing agent 34 is combusted by power distribution and heating of the ignition device 46 to discharge the aerosol. In other words, the activation signal is output to combust the solid extinguishing agent when the AND conditions that the transistor 132 is turned on by the activation ordering signal E1 and that the signal lines of the heat-sensitive cable 130 receive heat caused by fire are brought into contact with each other, and are short-circuited are satisfied. The AND activation operation is carried out as well also in the case in which the heat-sensitive cable 130 is short-circuited first, and the transistor 132 is then turned on by the activation ordering signal E1. By virtue of such AND activation of the fire detection using smoke and the fire detection using heat, even when there is an erroneous detection of fire due to, for example, smoke, the aerosol generating unit 14 is not erroneously activated, and erroneous alarming or erroneous operation caused by non-fire reporting can be reliably prevented.

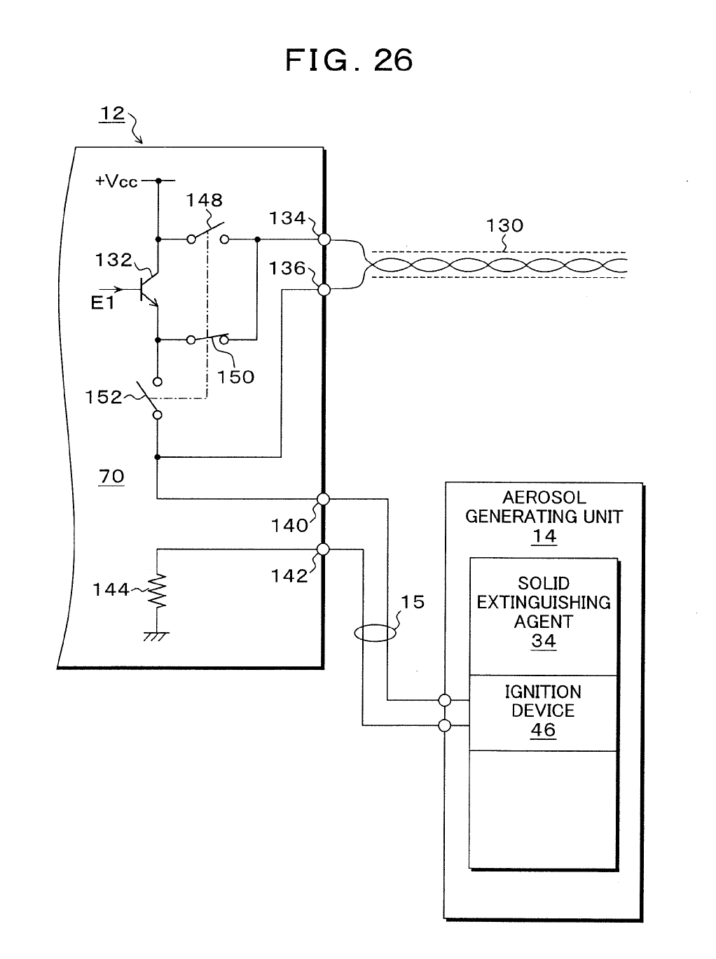

FIG. 25 is a circuit diagram showing an embodiment of the case in which the OR activation operation with the heat-sensitive cable is carried out by switching in the activation-signal outputting unit 70 provided in the disaster-preventing device 10 of FIGS. 22A and 22B. In FIG. 25, the activation-signal outputting unit 70 of the disaster-preventing device 10 is provided with the heat-sensitive terminals 134 and 136, which are connecting the signal lines of the heat-sensitive cable 130, and the activation terminals 140 and 142, which are connecting the activation signal line 15 with respect to the aerosol generating unit 14. In the activation-signal outputting unit 70, the transistor 132 is provided as a switching element to which the activation ordering signal E1 from the warning processing unit 86 is input when the event detecting unit 84 provided in the processor 60 detects fire based on the smoke detection signal from the smoke detecting unit 20 of FIGS. 22A and 22B; the collector side of the transistor 132 is connected to the heat-sensitive terminal 134 via a switch 148; and the emitter side thereof is connected to the heat-sensitive terminal 134 via a switch 150. Furthermore, the emitter side of the transistor 132 is connected to the activation terminal 140 via a switch 152, and the activation terminal 140 is connected to the heat-sensitive terminal 136. The activation terminals 140 and 142 are connected to the activation signal lines 15 and therefore are connected to the ignition device 46 of the solid extinguishing agent 34 housed in the aerosol generating unit 14. The connection and the role of the resistance 144 are the same as those of the embodiment of FIG. 23. The switches 148, 150, and 152 are switches of three circuits which can be manually operated or can be automatically controlled; and, for example, switch circuits utilizing various manual switches or switch elements such as relays can be applied. When the OR activation operation is to be set, as shown in the drawing, the switches 148 and 152 are turned on, and the switch 150 is switched to be turned off. In the OR activation operation, when the event detecting unit 84 provided in the processor 60 of FIGS. 22A and 22B detects an event of fire detection based on smoke detection by the smoke detecting unit 20, the activation ordering signal E1 is input from the warning processing unit 86 to the activation signal outputting unit 70; as a result, the transistor 132 is turned on, the activation signal is output to the activation signal lines 15 via the switch 152, in other words, an activation current flows; and the solid extinguishing agent 34 is combusted by power distribution and heating of the ignition device 46 to discharge the aerosol. On the other hand, when the insulating coating of the signal lines of the heat-sensitive cable 130 receives heat caused by fire in the device board and becomes a predetermined temperature, the insulating coating melts, and the two signal lines are therefore brought into contact with each other and obtain a short-circuited (conducted) state. In this case, the activation signal is output to the ignition device 46 to combust the solid extinguishing agent 34.

FIG. 26 is a circuit diagram showing the state in which the activation-signal outputting unit of FIG. 25 is switched to the AND activation operation. When the AND activation operation is to be set, the switches 148 and 152 are turned off, and the switch 150 switched to be turned on. In the AND activation operation, in the case in which the event detecting unit 84 provided in the processor 60 of FIGS. 22A and 22B detects an event of fire detection based on smoke detection by the smoke detecting unit 20, when the activation ordering signal E1 is input from the warning processing unit 86 to the activation-signal outputting unit 70, the transistor 132 is turned on. In this state, when the insulating coating of the signal lines of the heat-sensitive cable 130 receives heat caused by fire and becomes a predetermined temperature, the insulating coating melts, and the two signal lines are therefore brought into contact with each other to obtain a short-circuited (conducted) state. Through the contacted and short-circuited signal lines of the heat-sensitive cable 130, the activation signal is output to the activation signal line 15, in other words, an activation current flows, and the solid extinguishing agent 34 is combusted by power distribution and heating of the ignition device 46 to discharge the aerosol. In other words, the activation signal is output to the aerosol generating unit 14 to combust the solid extinguishing agent when the AND conditions that the transistor 132 is turned on by the activation ordering signal E1 and that the signal lines of the heat-sensitive cable 130 receive heat caused by fire and are short-circuited are satisfied. Herein, in the embodiments of FIGS. 22A and 22B to FIG. 26, the fire detecting unit 12 detects smoke to detect fire; however, fire may be detected by detecting heat.

Also in that case, the OR activation operation and the AND activation operation can be carried out based on the fire detection carried out by two mutually different fire detecting elements; therefore, fire can be precisely and reliably detected to activate the aerosol generating unit.

Furthermore, a plurality of heat-sensitive elements can be connected to one fire detecting unit (activation-signal outputting unit), and the OR or AND activation operation can be carried out by arbitrarily combining them. When the smoke detecting unit 20 is provided as the fire detecting unit 12 in the embodiment of FIGS. 1A and 1B, a smoke inlet of the smoke detecting unit 20 may be utilized as a discharging opening of the aerosol generating unit 14. In the above described embodiments, installation in the device board is taken as an example. However, the device can be installed on an arbitrary extinguishing object as long as it is a small closed space. The closed space is not necessarily sealed. Furthermore, the purpose is not limited to the case in which extinguishment of fire in closed space; and, for example, the device may be installed for a purpose to prevent fire, wherein occurrence of fire caused along with smoke generation, overheating, etc. is prevented.

FIG. 11, FIG. 12, FIG. 15, FIG. 16, and FIG. 17 are examples in which the device board 116-1 and the device board 116-2 are adjacent to each other. However, as a matter of course, these can be applied to the device boards which are at mutually-distant locations. The block diagrams shown in FIG. 6, FIG. 8, FIG. 22A and FIG. 22B are examples conceptually showing functional configurations, and these functional configurations can be arbitrarily distributed or integrated. For example, based on the smoke detecting signal from the smoke detecting unit, the process up to fire detection may be carried out in the sensor unit to output a fire detection signal, and the event detecting unit may be configured to detect it. For example, the event detecting unit may be integrated with the warning processing unit.

The flow charts in the above described embodiments are explaining schematic examples of processes, and the order, etc. of the processes are not limited thereto. Also, for example, delay time can be provided or other determination can be inserted in accordance with needs in the processes or between the process and the process.

The present invention is not limited to the above described embodiments, but includes arbitrary modifications that do not impair objects and advantages thereof, and is not limited by the numerical values shown in the above described embodiments.

1. A disaster-preventing device comprising:
a battery that supplies a power source;
a fire detecting unit that detects fire; and
an aerosol generating unit that, when the fire detecting unit detects the fire, generates and discharges, to outside, aerosol by combustion of a solid extinguishing agent.

2. The disaster-preventing device according to claim 1, wherein the fire detecting unit detects generation of smoke.

3. The disaster-preventing device according to claim 1, wherein the fire detecting unit and the aerosol generating unit are integrally provided.

4. The disaster-preventing device according to claim 1, wherein the fire detecting unit and the aerosol generating unit are disposed to be separated from each other;
the aerosol generating unit is connected to the fire detecting unit by a signal line; and,
the solid extinguishing agent is ignited and combusted by a signal output when the fire detecting unit detects the fire.

5. The disaster-preventing device according to claim 1, wherein
the fire detecting unit is provided with:
a sensor unit that outputs a detection signal corresponding to a physical phenomenon of a monitoring area;
an activation-signal outputting unit that outputs an activation signal to the aerosol generating unit;
an event detecting unit that detects whether there is the fire or not according to output of the detection signal of the sensor unit; and
a warning processing unit that, when the event detecting unit detects the fire, causes the activation-signal outputting unit to output the activation signal to the aerosol generating unit to combust the solid extinguishing agent.

6. The disaster-preventing device according to claim 5, wherein
the fire detecting unit is further provided with a transferred-alarm unit that outputs a transferred-alarm signal to another disaster-preventing device; and,
when the event detecting unit detects reception of a transferred-alarm signal from the other disaster-preventing device, the warning processing unit causes the activation-signal outputting unit to output the activation signal to the aerosol generating unit to combust the solid extinguishing agent.

7. The disaster-preventing device according to claim 5, wherein
the fire detecting unit is further provided with a transferred-alarm unit that outputs a transferred-alarm signal to another disaster-preventing device; and,
when the event detecting unit detects the fire and detects reception of a transferred-alarm signal from the other disaster-preventing device, the warning processing unit causes the activation-signal outputting unit to output the activation signal to the aerosol generating unit to combust the solid extinguishing agent.

8. The disaster-preventing device according to claim 1, wherein the fire detecting unit is provided with:
a sensor unit that outputs a detection signal corresponding to a physical phenomenon of a monitoring area;
an activation-signal outputting unit that outputs an activation signal to the aerosol generating unit;
an event detecting unit that detects whether there is the fire or not according to output of the detection signal of the sensor unit;
a transmission processing unit that wirelessly transmits an event signal to another disaster-preventing device;
a reception processing unit that wirelessly receives an event signal from the other disaster-preventing device; and
a warning processing unit that, when the event detecting unit detects the fire, causes the activation-signal outputting unit to output the activation signal to the aerosol generating unit to combust the solid extinguishing agent and further causes the transmission processing unit to wirelessly transmit an event signal indicating the fire to the other disaster-preventing device.

9. The disaster-preventing device according to claim 8, wherein, when the event detecting unit detects reception of the event signal indicating the fire from the other disaster-preventing device, the warning processing unit of the fire detecting unit causes the activation-signal outputting unit to output the activation signal to the aerosol generating unit to combust the solid extinguishing agent.

10. The disaster-preventing device according to claim 8, wherein, when the event detecting unit detects the fire and detects reception of the event signal indicating the fire from the other disaster-preventing device, the warning processing unit of the fire detecting unit causes the activation-signal outputting unit to output the activation signal to the aerosol generating unit to combust the solid extinguishing agent.

11. The disaster-preventing device according to claim 5, wherein the fire detecting unit is further provided with a heat-sensitive cable that is installed in a warning area and brings a pair of signal lines into contact with each other to obtain a short-circuited state by melting of insulating coating thereof when heat is received by the fire; and,
when the heat-sensitive cable is short-circuited, the activation-signal outputting unit outputs the activation signal to the aerosol generating unit to combust the solid extinguishing agent.

12. The disaster-preventing device according to claim 11, wherein the activation-signal outputting unit is provided with:
a switching element that is activated by an activation ordering signal output from the warning processing unit;
heat-sensitive terminals that connect the pair of signal lines of the heat-sensitive cable in parallel with the switching element; and
an activation line terminal that outputs the activation signal to the aerosol generating unit when the switching element is activated or when the heat-sensitive cable is short-circuited.

13. The disaster-preventing device according to claim 5, wherein the fire detecting unit is further provided with a heat-sensitive cable that brings a pair of signal lines into contact with each other to obtain a short-circuited state by melting of insulating coating thereof when heat is received by the fire; and,
when an activation ordering signal is output from the warning processing unit and the heat-sensitive cable is short-circuited, the activation-signal outputting unit outputs the activation signal to the aerosol generating unit to combust the solid extinguishing agent.

14. The disaster-preventing device according to claim 13, wherein the activation-signal outputting unit is provided with:
a switching element that is activated by an activation ordering signal output from the warning processing unit;
heat-sensitive terminals that connect the pair of signal lines of the heat-sensitive cable in series with the switching element; and
an activation line terminal that outputs the activation signal to the aerosol generating unit when the switching element is activated and the heat-sensitive cable is short-circuited.

15. The disaster-preventing device according to claim 5, wherein
the fire detecting unit is further provided with a heat-sensitive cable that is installed in a warning area and brings a pair of signal lines into contact with each other to obtain a short-circuited state by melting of insulating coating thereof when heat is received by the fire; and
the activation-signal outputting unit is provided with:
an OR activation unit that, when an activation ordering signal is output from the warning processing unit or when the heat-sensitive cable is short-circuited, outputs the activation signal to the aerosol generating unit to combust the solid extinguishing agent,
an AND activation unit that, when the activation ordering signal is output from the warning processing unit and the heat-sensitive cable is short-circuited, outputs the activation signal to the aerosol generating unit to combust the solid extinguishing agent, and
a switching unit that switches the OR activation unit and the AND activation unit.

16. The disaster-preventing device according to claim 1, wherein the aerosol generating unit is provided with:
the solid extinguishing agent that is provided with a communication hole from an opening on a surface to interior thereof and generates the extinguishing aerosol from the opening via the communication hole by combustion;
an ignition device that is housed in the communication hole and ignites and combusts the solid extinguishing agent;
an inner container that houses the solid extinguishing agent; and
an outer container that supports, in interior thereof, the inner container with interposition of heat-insulating space and have a plurality of discharging openings formed in an outer periphery.

17. The disaster-preventing device according to claim 1, wherein the aerosol generating unit is further provided with
a combustion controlling member that is provided with a discharging hole at a position corresponding to the opening of the solid extinguishing agent, is disposed to cover a surface of the solid extinguishing agent around the opening, and
suppresses combustion of the surface of the solid extinguishing agent due to flame emitted from the discharging hole.
